(19) United States
(12) Patent Application Publication
(10) Pub. No.: US 2024/0326809 A1
(43) Pub. Date: Oct. 3, 2024

(54) VEHICLE CONTROL DEVICE, STORAGE MEDIUM STORING COMPUTER PROGRAM FOR CONTROLLING VEHICLE AND METHOD FOR CONTROLLING VEHICLE

(71) Applicant: TOYOTA JIDOSHA KABUSHIKI KAISHA, Toyota-shi Aichi-ken (JP)

(72) Inventors: Takuo Kaneko, Bunkyo-ku Tokyo-to (JP); Ryo Hashimoto, Edogawa-ku Tokyo-to (JP); Suzuka Kondo, Nishitokyo-shi Tokyo-to (JP)

(73) Assignee: TOYOTA JIDOSHA KABUSHIKI KAISHA, Toyota-shi Aichi-ken (JP)

(21) Appl. No.: 18/595,728

(22) Filed: Mar. 5, 2024

(30) Foreign Application Priority Data
Mar. 30, 2023 (JP) 2023-055543

(51) Int. Cl. B60W 30/16

(52) U.S. Cl. CPC B60W 30/16; B60W 2520/10; B60W 2554/4045; B60W 2554/80; B60W 2556/40

(57) ABSTRACT

A vehicle control device has a processor configured to estimate whether an adjacent vehicle moves into the traveling lane ahead of a host vehicle in the merging terrain based on distance of a front vehicle with respect to the host vehicle, distance of the adjacent vehicle with respect to the host vehicle, and speed of the host vehicle, when there is the front vehicle and there is the adjacent vehicle, and set a first inter-vehicle distance between the front vehicle and the host vehicle in the traveling lane based on the distance of the front vehicle with respect to the host vehicle and the speed of the host vehicle or set a second inter-vehicle distance between the adjacent vehicle and the host vehicle in the traveling lane based on the speed of the host vehicle, when the adjacent vehicle moves into the traveling lane ahead of the host vehicle.

### CROSS-REFERENCE TO RELATED APPLICATIONS

This application claims priority to Japanese Patent Application No. 2023-055543 filed on Mar. 30, 2023, the entire contents of which are herein incorporated by reference.

### FIELD

The present disclosure relates to a vehicle control device, storage medium storing a computer program for controlling a vehicle and method for controlling a vehicle.

### BACKGROUND

An automatic control system mounted on a vehicle generates a navigation route of the vehicle based on the current position of the vehicle, the target position of the vehicle, and the map for navigation. The automatic control system estimates the current position of the vehicle using map information and controls the vehicle to run along the navigation route.

The navigation route sometimes includes a merging terrain where an adjacent lane adjacent to a traveling lane in which a host vehicle is traveling disappears by merging with the traveling lane. In the merging terrain, an adjacent vehicle traveling in the adjacent lane moves to the traveling lane. Further, there is a case where a front vehicle is traveling in the traveling lane ahead of the host vehicle. In such a case, the automatic control system of the host vehicle generates a space in which the adjacent vehicle can move between the front vehicle and the host vehicle the adjacent vehicle (e.g., Japanese Unexamined Patent Publication No. 2015-153153).

### SUMMARY

In some embodiments, in the merging terrain, when the adjacent vehicle moves between the host vehicle and the front vehicle, an appropriate inter-vehicle distance is set between the host vehicle and the front vehicle, or, between the host vehicle and the adjacent vehicle. Thus, safe running of each vehicle is ensured.

Accordingly, an object of the present disclosure is to provide a vehicle control device capable of setting an appropriate inter-vehicle distance between the host vehicle and the front vehicle or between the host vehicle and the adjacent vehicle so that the adjacent vehicle can safely move between the host vehicle and the front vehicle in the merging terrain.

(1) According to one embodiment, a vehicle control device is provided. The vehicle control device has a processor configured to determine whether there is a merging terrain where an adjacent lane adjacent to a traveling lane in which a host vehicle is traveling disappears by merging with the traveling lane within a first predetermined range from a current position of the host vehicle toward a traveling direction based on map information, determine whether there is a front vehicle traveling in the traveling lane ahead of the host vehicle within a second predetermined range from the host vehicle and determine whether there is an adjacent vehicle traveling in the adjacent lane within a third predetermined range from the host vehicle based on surrounding environment information of the host vehicle, when it has been determined that there is the merging terrain, estimate whether the adjacent vehicle moves into the traveling lane ahead of the host vehicle in the merging terrain based on distance of the front vehicle with respect to the host vehicle, distance of the adjacent vehicle with respect to the host vehicle, and speed of the host vehicle, when it has been determined that there is the front vehicle and there is the adjacent vehicle, and set a first inter-vehicle distance between the front vehicle and the host vehicle in the traveling lane based on the distance of the front vehicle with respect to the host vehicle and the speed of the host vehicle or set a second inter-vehicle distance between the adjacent vehicle and the host vehicle in the traveling lane based on the speed of the host vehicle, when it has been estimated that the adjacent vehicle moves into the traveling lane ahead of the host vehicle.

(2) In some embodiments, in the vehicle control device of (1), the processor is further configured to set a value obtained by adding the distance of the front vehicle with respect to the host vehicle with a distance determined based on the relationship between the distance of the adjacent vehicle with respect to the host vehicle and the speed of the vehicle when the adjacent vehicle moves into the traveling lane ahead of the host vehicle, as the first inter-vehicle distance.

(3) In some embodiments, in the vehicle control device of (2), the processor is further configured to set the first inter-vehicle distance so that the adjacent vehicle is positioned between the front vehicle and the host vehicle.

(4) In some embodiments, in the vehicle control device of (2) or (3), the processor is further configured to determine whether there is another adjacent vehicle traveling behind the adjacent vehicle in the adjacent lane within a fourth predetermined range from the host vehicle, and set the first inter-vehicle distance to be a length at which another adjacent vehicle cannot be located between the front vehicle and the host vehicle based on the distance of the front vehicle with respect to the host vehicle, distance of another adjacent vehicle with respect to the host vehicle and the speed of the host vehicle, when it has been determined that there is another adjacent vehicle and it is estimated that the adjacent vehicle moves into the traveling lane ahead of the host vehicle.

(5) In some embodiments, in any one of the vehicle control devices of (2) to (4), the processor is further configured to set the first inter-vehicle distance equal to or below a length determined based on the relationship between the distance of the front vehicle with respect to the host vehicle and the speed of the host vehicle.

(6) In some embodiments, in any one of the vehicle control device of (1) to (5), the processor is further configured to estimate whether the adjacent vehicle moves into the traveling lane ahead of the host vehicle using a regression equation in which the distance of the front vehicle with respect to the host vehicle, the distance of the adjacent vehicle with respect to the host vehicle and the speed of the vehicle are variables.

(7) In some embodiments, in the vehicle control device of (1), the processor is further configured to set a length determined based on the relationship between the distance of the adjacent vehicle with respect to the host vehicle and the speed of the host vehicle when the adjacent vehicle moves into the traveling lane ahead of the host vehicle, as the second inter-vehicle distance.

(8) In some embodiments, in any of the vehicle control device of (1) to (7), the processor is further configured to estimate whether the adjacent vehicle moves into the traveling lane ahead of the host vehicle in the merging terrain based on the distance of the front vehicle with respect to the host vehicle, the distance of the adjacent vehicle with respect to the host vehicle, and speed of the host vehicle, when an absolute value of relative speed of the adjacent vehicle with respect to the host vehicle is equal to or above a first reference speed, and estimate whether the adjacent vehicle moves into the traveling lane ahead of the host vehicle in the merging terrain based on the distance of the front vehicle with respect to the host vehicle and the distance of the adjacent vehicle with respect to the host vehicle, when the absolute value of relative speed of the adjacent vehicle with respect to the host vehicle is less than the first reference speed.

(9) In some embodiments, in any one of the vehicle control device of (1) to (8), the processor is further configured to estimate whether the adjacent vehicle moves into the traveling lane ahead of the host vehicle in the merging terrain based on the distance of the front vehicle with respect to the host vehicle, the distance of the adjacent vehicle with respect to the host vehicle, and speed of the host vehicle, when the speed of the host vehicle is equal to or above a second reference speed, and estimate whether the adjacent vehicle moves into the traveling lane ahead of the host vehicle in the merging terrain based on the distance of the front vehicle with respect to the host vehicle and the distance of the adjacent vehicle with respect to the host vehicle, when the speed of the host vehicle is less than the second reference speed.

(10) In some embodiments, in any one of the vehicle control device of (1) to (9), the processor is further configured to set the first inter-vehicle distance when the distance of the front vehicle with respect to the host vehicle is less than or equal to a predetermined reference distance, and set the second inter-vehicle distance when the distance of the front vehicle with respect to the host vehicle is above the predetermined reference distance.

(11) According to another embodiment, a storage medium storing a computer program for controlling a vehicle is provided. The computer program for vehicle control causes a processor to execute a process and the process includes determining whether there is a merging terrain where an adjacent lane adjacent to a traveling lane in which a host vehicle is traveling disappears by merging with the traveling lane within a first predetermined range from a current position of the host vehicle toward a traveling direction based on map information, determining whether there is a front vehicle traveling in the traveling lane ahead of the host vehicle within a second predetermined range from the host vehicle and determine whether there is an adjacent vehicle traveling in the adjacent lane within a third predetermined range from the host vehicle based on surrounding environment information of the host vehicle, when it has been determined that there is the merging terrain, estimating whether the adjacent vehicle moves into the traveling lane ahead of the host vehicle in the merging terrain based on distance of the front vehicle with respect to the host vehicle, distance of the adjacent vehicle with respect to the host vehicle, and speed of the host vehicle, when it has been determined that there is the front vehicle and there is the adjacent vehicle, and setting a first inter-vehicle distance between the front vehicle and the host vehicle in the traveling lane based on the distance of the front vehicle with respect to the host vehicle and the speed of the host vehicle or set a second inter-vehicle distance between the adjacent vehicle and the host vehicle in the traveling lane based on the speed of the host vehicle, when it has been estimated that the adjacent vehicle moves into the traveling lane ahead of the host vehicle.

(12) According to yet another embodiment, a vehicle control method is provided. The vehicle control method is carried out by a vehicle control device, and the method includes determining whether there is a merging terrain where an adjacent lane adjacent to a traveling lane in which a host vehicle is traveling disappears by merging with the traveling lane within a first predetermined range from a current position of the host vehicle toward a traveling direction based on map information, determining whether there is a front vehicle traveling in the traveling lane ahead of the host vehicle within a second predetermined range from the host vehicle and determine whether there is an adjacent vehicle traveling in the adjacent lane within a third predetermined range from the host vehicle based on surrounding environment information of the host vehicle, when it has been determined that there is the merging terrain, estimating whether the adjacent vehicle moves into the traveling lane ahead of the host vehicle in the merging terrain based on distance of the front vehicle with respect to the host vehicle, distance of the adjacent vehicle with respect to the host vehicle, and speed of the host vehicle, when it has been determined that there is the front vehicle and there is the adjacent vehicle, and setting a first inter-vehicle distance between the front vehicle and the host vehicle in the traveling lane based on the distance of the front vehicle with respect to the host vehicle and the speed of the host vehicle or set a second inter-vehicle distance between the adjacent vehicle and the host vehicle in the traveling lane based on the speed of the host vehicle, when it has been estimated that the adjacent vehicle moves into the traveling lane ahead of the host vehicle.

According to the present disclosure, the vehicle control device can set an appropriate inter-vehicle distance between the host vehicle and the front vehicle or between the host vehicle and the adjacent vehicle so that the adjacent vehicle can safely move between the host vehicle and the front vehicle in the merging terrain.

The object of the present disclosure will be realized and attained by the elements and combinations particularly indicated in the claims. It is to be understood that both the foregoing general description and the following detailed description are exemplary and explanatory, and are not restrictive of the present disclosure, as claimed.

### BRIEF DESCRIPTION OF DRAWINGS

FIG. 1 is a diagram for explaining an outline of the operation of the inter-vehicle distance setting device of the first embodiment.

FIG. 2 is a schematic configuration diagram of a vehicle in which the inter-vehicle distance setting device of the first embodiment is mounted.

FIG. 3 is an example of an operation flowchart relating to the vehicle control process of the inter-vehicle distance setting device of the first embodiment.

FIG. 4 is a diagram for explaining an estimation process of the inter-vehicle distance setting device of the first embodiment.

FIG. 5 is an example of an operation flowchart relating to the inter-vehicle distance setting process of the inter-vehicle distance setting device of the first embodiment.

FIG. 6 is a diagram showing the relationship between the distance of the adjacent vehicle with respect to the vehicle and the speed of the vehicle.

FIG. 7 is a diagram for explaining setting the inter-vehicle distance.

FIG. 8 is a diagram showing the relationship between the distance of the front vehicle with respect to the vehicle and the speed of the vehicle.

FIG. 9 is a diagram for explaining an outline of the operation of an modified example of the inter-vehicle distance setting device of the first embodiment.

FIG. 10 is an example of an operation flowchart of the inter-vehicle distance setting process in the modified example of the inter-vehicle distance setting device of the first embodiment.

FIG. 11 is a diagram for explaining setting the inter-vehicle distance.

FIG. 12 is an example of an operation flowchart relating to the vehicle control process of the inter-vehicle distance setting device of the second embodiment.

FIG. 13 is an example of an operation flowchart relating to the inter-vehicle distance setting process of the inter-vehicle distance setting device of the second embodiment.

FIG. 14 is a diagram for explaining setting the inter-vehicle distance.

FIG. 15 is an example of an operation flowchart of the inter-vehicle distance setting process in the modified example of the inter-vehicle distance setting device of the second embodiment.

FIG. 16 is a diagram for explaining setting the inter-vehicle distance.

FIG. 17 is a diagram for explaining another inter-vehicle distance setting process of the inter-vehicle distance setting device.

FIG. 18 is a diagram for explaining another estimation process of the inter-vehicle distance setting device.

FIG. 19 is a diagram for explaining still another estimation process of the inter-vehicle distance setting device.

### DESCRIPTION OF EMBODIMENTS

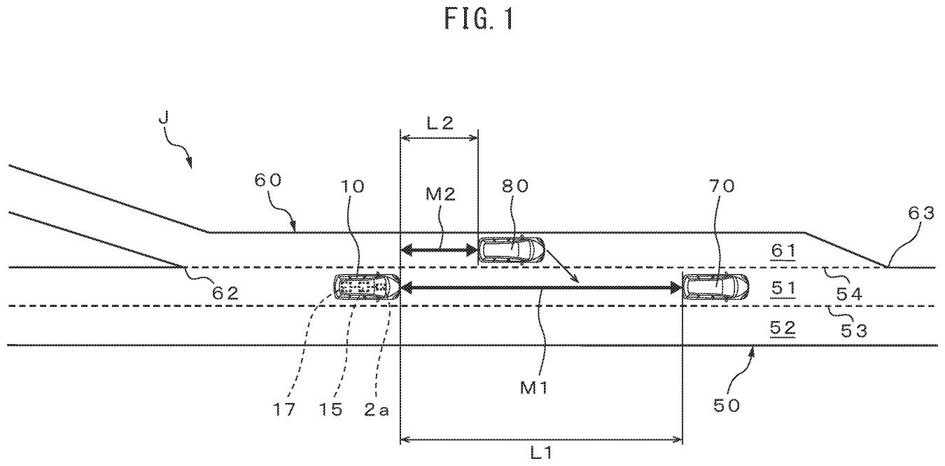

FIG. 1 is a diagram for explaining an outline of the operation of the inter-vehicle distance setting device 17 of the first embodiment. Hereinafter, with reference to FIG. 1, an outline of the operation related to the vehicle control processing of the inter-vehicle distance setting device 17 of the first embodiment disclosed herein will be described. The inter-vehicle distance setting device 17 is an example of a vehicle control device. The vehicle 10 may be an autonomous vehicle.

As shown in FIG. 1, the vehicle 10 is traveling on a lane 51 of a road 50 having lanes 51, 52. The lane 51 and the lane 52 is divided by the lane division line (lane boundary line) 53. The vehicle 10 is traveling in the lane 51 of the road 50. The lane 51 on the road 50 is an example of a traveling lane. The vehicle 10 is an example of the host vehicle.

The vehicle 10 has an operation planning device 15 and an inter-vehicle distance setting device 17. The inter-vehicle distance setting device 17 sets the inter-vehicle distance between another vehicle located ahead of the traveling lane in which the vehicle 10 travels and the vehicle 10. The operation planning device 15 generates an operation plan based on the present position of the vehicle 10, map information, information acquired by a sensor such as a camera 2a, and the like. The operation plan represents the scheduled travel locus of the vehicle 10 up to a predetermined time ahead. The vehicle 10 may be an autonomous vehicle.

The inter-vehicle distance setting device 17 determines that there is a merging terrain J in the most recent driving section, based on the current position of the vehicle 10 and the map information. Then, the vehicle 10 is currently running in the merging terrain J. The most recent driving section is an example of a predetermined range from the current position of the vehicle 10 toward the traveling direction.

In the merging terrain J, the road 60 merges with the road 50. The road 60 has a lane 61. In the merging terrain J, the lane 61 of the road 60 and the lane 51 of the road 50 are connected between the merging start position 62 and the merging end position 63. The lane 61 of the road 60 is adjacent to the lane 51 of the road 50 on which the vehicle 10 is traveling. The lane 61 and the lane 51 is divided by the lane division line (lane boundary line) 54. In the merging terrain J, the lane 61 of the road 60 is disappears by merging with the lane 51. The lane 61 is an example of an adjacent lane.

The inter-vehicle distance setting device 17 determines that there is a vehicle 70 which travels in a lane 51 ahead of the vehicle 10 within a predetermined range from the vehicle 10 based on information acquired by a sensor such as a camera 2a. The vehicle 70 is an example of a front vehicle.

In addition, the inter-vehicle distance setting device 17 determines that there is a vehicle 80 traveling in the lane 61 of the road 60 within a predetermined range from the vehicle 10 based on information acquired by a sensor such as the camera 2a. In the merging terrain J, the vehicle 80 traveling in the lane 61 of the road 60 moves from the lane 61 to the lane 51. The vehicle 80 is an example of an adjacent vehicle.

The inter-vehicle distance setting device 17 estimates whether or not the vehicle 80 moves to the lane 51 ahead of the vehicle 10 in the merging terrain J based on the distance L1 of the vehicle 70 with respect to the vehicle 10, the distance L2 of the vehicle 80 with respect to the vehicle 10, and the speed of the vehicle 10.

In the example shown in FIG. 1, the inter-vehicle distance setting device 17 estimates that the vehicle 80 moves to the lane 51 in front of the vehicle 10. The inter-vehicle distance setting device 17 sets the first inter-vehicle distance M1 between the vehicle 70 and the vehicle 10 on the lane 51 based on the distance L1 of the vehicle 70 with respect to the vehicle 10, the distance L2 of the vehicle 80 with respect to the vehicle 10, and the speed of the vehicle 10.

In some embodiments, the inter-vehicle distance setting device 17 sets the first inter-vehicle distance M1 so that a large speed change or acceleration change does not occur with respect to the vehicle 10. In some embodiments, the inter-vehicle distance setting device 17 sets the first inter-vehicle distance M1 so that the driver of the vehicle 10 does not feel that the distance between the vehicle 10 and the vehicle 70 is too large. The driving planning device 15 generates a driving plan such that the first inter-vehicle distance M1 is maintained between the vehicle 70 and the vehicle 10 on the lane 51.

As described above, the inter-vehicle distance setting device 17 sets the appropriate inter-vehicle distance between the vehicle 10 and the vehicle 70 so that the vehicle 80 can safely move between the vehicle 10 and the vehicle 70 in the merging terrain J.

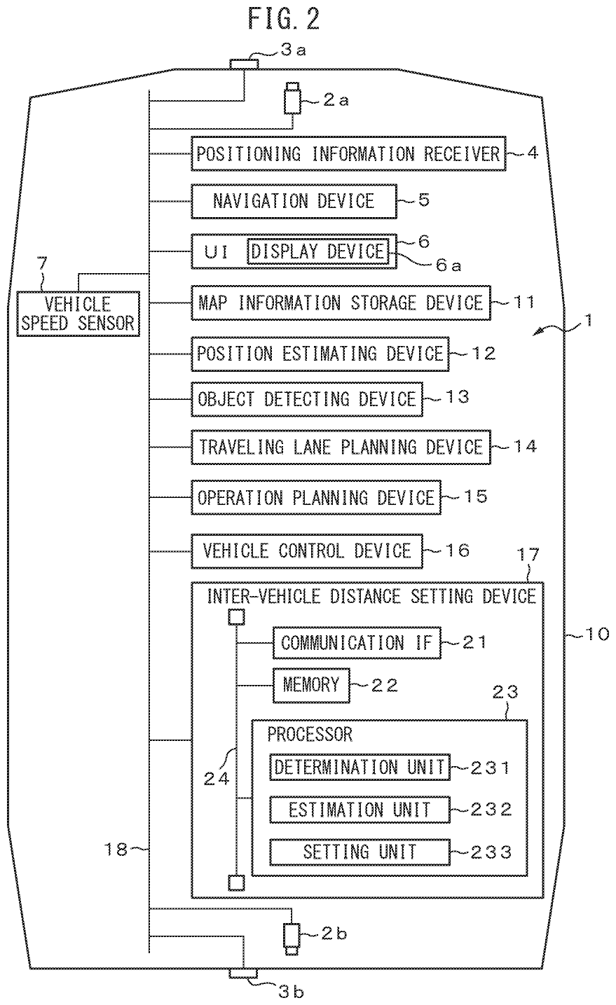

FIG. 2 is a schematic configuration diagram of a vehicle 10 in which the inter-vehicle distance setting device 17 of this embodiment is mounted. The vehicle 10 includes a camera 2a, 2b, a LiDAR sensor 3a, 3b, a positioning information receiver 4, a navigation device 5, a user interface (UI) 6, a vehicle speed sensor 7, a map information storage device 11, a position estimating device 12, an object detecting device 13, a traveling lane planning device 14, an operation planning device 15, a vehicle control device 16, and an inter-vehicle distance setting device 17 or the like. In addition, the vehicle 10 may have a ranging sensor (e.g., millimeter wave radar) for measuring the distance to objects surrounding the vehicle 10. The vehicle control system 1 includes at least a camera 2a, 2b, a LIDAR sensor 3a, 3b, and an inter-vehicle distance setting device 17.

The camera 2a, 2b, LiDAR sensor 3a, 3b, the positioning information receiver 4, the navigation device 5, UI 6, the vehicle speed sensor 7, the map information storage device 11, the position estimating device 12, the object detecting device 13, the traveling lane planning device 14, the operation planning device 15, the vehicle control device 16, and the inter-vehicle distance setting device 17 are communicatively connected through the in-vehicle network 18 conforming to the standards such as the controller area network.

The camera 2a, 2b are an exemplary imaging units provided in the vehicle 10. The cameras 2a is mounted to the vehicle 10 so as to face the front of the vehicle 10. The camera 2b is mounted to the vehicle 10 so that it faces the rear of the vehicle 10. The camera 2a, 2b, for example, at a camera image capturing time which is set at a predetermined cycle, captures a camera image in which the environments of an area within a predetermined field of view in front and rear of the vehicle 10 are represented. The camera image may represent roads contained within predetermined areas in front and rear of the vehicle 10 and road features such as lane markings on the road surface thereof. Each of the camera 2a, 2b has a two-dimensional detector composed of arrays of photoelectric conversion elements sensitive to visible light, such as CCD or C-MOS. Further, each of the camera 2a, 2b has an imaging optical system for imaging an image of an area to be photographed on a two-dimensional detector. The camera image is an example of surrounding environment information.

The camera 2a, 2b outputs the camera image and the camera image capturing time to the position estimating device 12, the object detecting device 13, or the like via the in-vehicle network 18 each time the camera image is captured. The camera image is used in the process of estimating the position of the vehicle 10 in the position estimating device 12. The camera image is also used in the process of detecting other objects around the vehicle 10 in the object detecting device 13.

The LiDAR sensor 3a is attached to, for example, the outer surface of the vehicle 10 so as to face the front of the vehicle 10. The LiDAR sensor 3b is, for example, mounted on the outer surface of the vehicle 10 so as to face the rear of the vehicle 10. Each of the LiDAR sensor 3a, 3b emits the laser to scan toward a predetermined field of view in front of and behind the vehicle 10 at a reflected wave information acquisition time that is set at a predetermined period. Then, each of the LiDAR sensor 3a, 3b receives the reflection wave reflected by the reflective object. The time taken for the reflected wave to return has distance information between other objects located in the direction in which the laser is emitted and the vehicle 10. The LiDAR sensor 3a, 3b output the reflected wave information to the object detecting device 13 or the like through the in-vehicle network 18 together with the reflected wave information acquisition time in which the laser is emitted. The reflected wave information includes the radiation direction of the radar and the time required for the reflected wave to return. The reflected wave information acquisition time represents the time when the radar was fired. The reflected anti-wave information is used in the object detection apparatus 13 to detect other objects around the vehicle 10. The reflected wave information is an example of surrounding environment information.

The positioning information receiver 4 outputs the positioning information representing the current position of the vehicle 10. For example, the positioning data receiver 4 can be a GNSS receiver. The positioning information receiver 4 outputs the positioning information and the positioning information acquisition time to the navigation device 5, the map information storage device 11, or the like each time the positioning information is acquired in a predetermined reception period. The positioning information acquisition time represents the time when the positioning information was acquired.

The navigation device 5 generates a navigation route from the current position of the vehicle 10 to the target position based on the navigation map information, the target position of the vehicle 10, and the positioning information. The positioning information represents the current position of the vehicle 10 input from the positioning information receiver 4. Navigation route includes information about positions such as right turn, left turn, merging, branching, etc. The navigation device 5 newly generates the navigation route of the vehicle 10 when the target position is newly set or when the current position of the vehicle 10 is out of the navigation route. Each time the navigation route is generated, the navigation device 5 outputs the navigation route to the position estimating device 12, the traveling lane planning device 14, the operation planning device 15, and the inter-vehicle distance setting device 17 through the in-vehicle network 18. The navigation device 5 does not generate a navigation route when the target position is not set.

UI 6 is an exemplary notification unit. The UI 6 is controlled by the navigation device 5 and the operation planning device 15 to notify the driving information of the vehicle 10 and the like to the driver. The travel information of the vehicle 10 includes information about the current position of the vehicle, the path of the vehicle, and the like. Information on vehicle routes includes navigation routes. The UI 6 has a display device 6a such as a liquid crystal display or a touch panel in order to display travel information or the like. The UI 6 may also have a sound-output device (not shown) for notifying the driver of travel information and the like. The UI 6 also generates operational signaling in response to operations on the vehicle 10 from the driver. As the operation information, for example, the target position, the waypoint, the speed of the vehicle, and the like. The UI 6 includes, for example, a touch panel or an operation button as an input device for inputting operation information from the driver to the vehicle 10. The UI 6 transmits the input operation data to other devices through the in-vehicle network 18. The other devices include the navigation device 5 and the operation planning device 15, etc.

The vehicle speed sensor 7 detects speed information representing the speed of the vehicle 10. The vehicle speed sensor 7 includes, for example, a measuring unit for measuring the rotational speed of the tire of the vehicle 10. The vehicle speed sensor 7 outputs the speed information to the operation planning device 15, the inter-vehicle distance setting device 17, or the like through the in-vehicle network 18. The speed information is used in the process of determining the speed of the vehicle 10 in the operation planning device 15 and the inter-vehicle distance setting device 17.

The map information storage device 11 stores the map information of a wide area of a relatively wide range including the present position of the vehicle 10 (e.g., 10 km to 30 km square range). This map information has high-precision map information including information representing the three-dimensional information of the road surface, limited speed of the road, curvature of the road, road features such as lane division lines on the road, type and positions of structures, etc.

The map information storage device 11 receives wide area map information from an external server through a base station and stores it in the storage device by wireless communication via a wireless communication device (not shown) mounted on the vehicle 10 in accordance with the current position of the vehicle 10. The map information storage device 11, each time inputting the positioning information from the positioning information receiver 4, refers to the map information of the wide area being stored, the map information of the relatively narrow area including the current position represented by the positioning information (e.g., the range of 100 m² to 10 km²), via the vehicle network 18, and outputs to other devices. The other devices include the position estimating device 12, the traveling lane planning device 14, the driving planning device 15, the vehicle control device 16, and the inter-vehicle distance setting device 17.

The position estimating device 12 estimates the position of the vehicle 10 at the camera image capturing time based on the road features around the vehicle 10 represented in the camera image captured by the camera 2a or the camera 2b. For example, the position estimating device 12 compares the lane division line identified in the camera image with the lane division line represented in the map information input from the map information storage device 11 to obtain the estimated position and the estimated azimuth angle of the vehicle 10 at the camera image capturing time. The position estimating device 12 estimates the traveling lane on the road where the vehicle 10 is located based on the lane division line represented by the map information and the estimated position and the estimated azimuth angle of the vehicle 10. The position estimating device 12 outputs the estimated position, the estimated azimuth angle, and the traveling lane of the vehicle 10 to other devices. Th other devices include a traveling lane planning device 14, a driving planning device 15, a vehicle control device 16, and an inter-vehicle distance setting device 17.

The object detecting device 13 detects an object and its type around the vehicle 10 based on the camera image. The object includes a vehicle that travels around the vehicle 10. The object detecting device 13, for example, has a discriminator for detecting an object represented in the image by inputting a camera image.

As the discriminator, for example, a deep neural network (DNN) trained in advance so as to detect an object represented in the image from the input image can be used. The object detecting device 13 may use a discriminator other than the DNN. For example, the object detecting device 13 may use a support vector machine (SVM) as a discriminator. Alternatively, the object detecting device 13 may detect the object area by performing template matching between the template represented by the object to be detected and the image.

The object detecting device 13 may also detect an object around the vehicle 10 based on the reflected wave information. The object detecting device 13 determines the orientation of the object with respect to the vehicle 10 based on the position of the object in the camera image, and based on this orientation and the reflected wave information, the distance between the object and the vehicle 10 may be determined. The object detecting device 13 estimates the position of an object, for example, represented in a world coordinate system, based on the current position of the vehicle 10 and the distance and orientation to the object relative to the vehicle 10. The object detecting device 13 may also track an object detected from the latest image by associating the object detected from the latest camera image with the object detected from the past image according to the tracking process based on the optical flow. Then, the object detecting device 13 may obtain the trajectory of the object being tracked based on the position represented by the world coordinate system of the object in the latest image from the past image. The object detecting device 13 can estimate the speed of that object relative to the vehicle 10 based on changes in the position of the object over time. Further, the object detecting device 13 can estimate the acceleration of the object based on the change in the speed of the object with time. Further, the object detecting device 13 specifies the traveling lane in which the object is traveling based on the lane division line represented by the map information and the position of the object. For example, the object detecting device 13 determines that the object is traveling in a lane specified by two lane division lines adjacent to each other located so as to sandwich the center position of the object in the horizontal direction.

Further, the object detecting device 13 may have a discriminator for detecting an object represented in the reflection wave information by inputting the reflected wave information. As the discriminator, for example, a deep neural network (DNN) trained in advance to detect an object represented in the reflection wave information from the input reflected wave information can be used. The object detecting device 13 may detect an object around the vehicle 10 and its type based on the camera image and the reflected wave information. The object detecting device 13 may also detect an object around the vehicle 10 and its type based on the camera image. In addition, the object detecting device 13 may detect objects and their types around the vehicle 10 based on the reflected wave information.

The object detecting device 13 notifies the operation planning device 15, the inter-vehicle distance setting device 17, or the like of the object detection information. The object detection information includes information indicating the type of the detected object and information indicating the position, the speed, the acceleration, and the traveling lane. If a plurality of adjacent vehicles is detected, the object detecting device 13 notifies the inter-vehicle distance setting device 17 of the object detection information including vehicle identification information identifying each of the plurality of adjacent vehicles.

The traveling lane planning device 14 selects a lane in the road on which the vehicle 10 is traveling based on the map information, the navigation route and the surrounding environment information, and the present position of the vehicle 10 in the most recent driving section (for example, 10 km) selected from the navigation route at the traveling lane plan generation time set in a predetermined cycle, and generates a traveling lane plan representing the traveling lane on which the vehicle 10 is planned to travel. The traveling lane planning device 14 generates a traveling lane plan such that the vehicle 10 travels in a lane other than the overtaking lane, for example. The traveling lane planning device 14 outputs the traveling lane plan to the operation planning device 15 or the like each time the traveling lane plan is generated.

The operation planning device 15 generates an operation plan representing a scheduled travel locus of the vehicle 10 up to a predetermined time (for example, 5 seconds) ahead based on the driving plan generation time set in a predetermined cycle, a traveling lane plan, map information, the current position of the vehicle 10, the surrounding environment information, and the vehicle state information. In some embodiments, the operation plan is generated so as to satisfy a predetermined limit. As a predetermined limit, acceleration, deceleration, yaw rate, and the like are exemplified. The surrounding environment information includes the position and speed of another vehicle traveling around the vehicle 10, and the like. The vehicle status information includes the current position of the vehicle 10, the vehicle speed, the acceleration, the traveling direction, and the like. Further, when there is a front vehicle traveling in front of the vehicle 10, the operation planning device 15 generates an operation plan so as to maintain the inter-vehicle distance set by the inter-vehicle distance setting device 17. The operation plan is expressed as a set of the target position of the vehicle 10 and the target vehicle speed at the target position at each time from the current time up to the predetermined time ahead. In some embodiments, the period at which the driving plan is generated is shorter than the period at which the traveling lane plan is generated. The operation planning device 15 generates an operation plan so that an interval of a predetermined distance or more can be maintained between the vehicle 10 and an object. The object includes a vehicle. Operation planning device 15, outputs the operation plan to the vehicle control device 16 each time it generates the operation plan.

The vehicle control device 16 controls each part of the vehicle 10 based on the current position of the vehicle 10, the vehicle speed and yaw rate, and the operation plan. For example, the vehicle control device 16 determines the steering angle, acceleration, and angular acceleration of the vehicle 10 according to an operation plan, vehicle speed, and yaw rate. The vehicle control device 16 sets the steering amount, the degree of acceleration, or the brake amount so as to be the steering angle, the acceleration, and the angular acceleration. Then, the vehicle control device 16 outputs a control signal according to the set steering amount to an actuator (not shown) for controlling the steering wheel of the vehicle 10 through the in-vehicle network 18. Further, the vehicle control device 16 outputs a control signal corresponding to the set degree of acceleration to the driving device of the vehicle 10 (not shown) through the in-vehicle network 18. The drive includes an engine or motor. Alternatively, the vehicle control device 16 outputs a control signal corresponding to the set brake amount to the brake of the vehicle 10 (not shown) via the in-vehicle network 18.

The inter-vehicle distance setting device 17 executes a determination process, an estimation process, and a setting process. To this end, the operation planning device 15 includes a communication interface (IF) 21, memory 22, and processor 23). The communication interface 21, the memory 22, and the processor 23 are connected via a signal line 24. The communication interface 21 includes interface circuitry for connecting the inter-vehicle distance setting device 17 to the in-vehicle network 18.

The memory 22 is an example of a storage unit, for example, a volatile semiconductor memory and a non-volatile semiconductor memory. The memory 22 then stores computer programs and various types of data for applications used in information processing performed by the processor 23.

All or a part of functions of the inter-vehicle distance setting device 17 is a functional module realized by a computer program running on the processor 23, for example. The processor 23 includes a determination unit 231, an estimation unit 232, and a setting unit 233.

Alternatively, the functional module of the processor 23 may be a dedicated arithmetic circuit provided in the processor 23. The processor 23 includes one or more CPUs (Central Processing Unit) and its peripheral circuitry. The processor 23 may further include other operational circuitry, such as a logic unit, a numerical unit, or a graphic processing unit.

The map-information storage device 11, the position estimating device 12, the object detecting device 13, the traveling lane planning device 14, the operation planning device 15, the vehicle control device 16, and the inter-vehicle distance setting device 17 are, for example, an electronic control device (Electronic Control Unit: ECU). In FIG. 2, although the map information storage device 11, the position estimating device 12, the object detecting device 13, the traveling lane planning device 14, the operation planning device 15, the vehicle control device 16, and the inter-vehicle distance setting device 17 are described as separate devices, all or a part of these devices may be configured as one device.

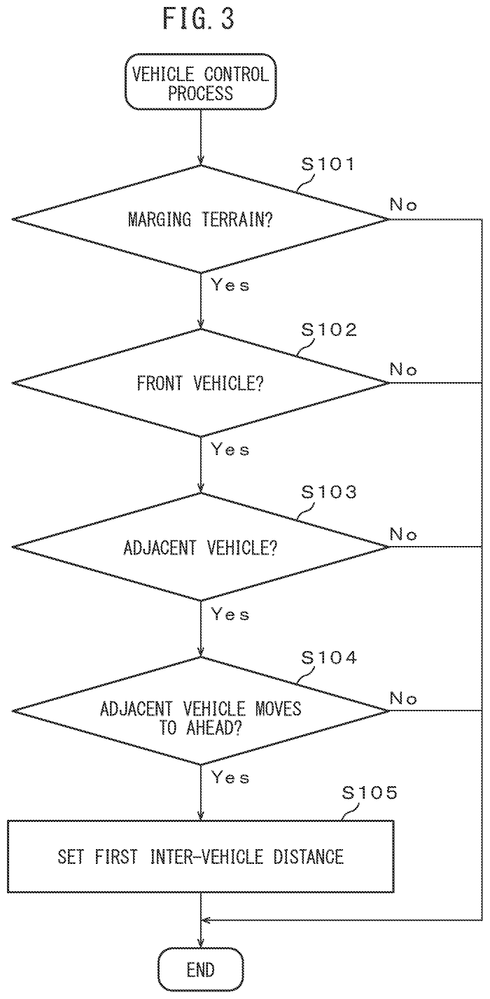

FIG. 3 is an example of an operation flowchart relating to the vehicle control process of the inter-vehicle distance setting device 17 of the present embodiment. Referring to FIG. 3, the vehicle control processing of the inter-vehicle distance setting device 17 will be described below. The inter-vehicle distance setting device 17, at the vehicle control time having a predetermined period, executes the vehicle control processing in accordance with the operation flowchart shown in FIG. 3.

First, the determination unit 231 determines whether or not there is a merging terrain within a predetermined range from the present position of the vehicle 10 toward the front of the course of the vehicle 10 (S101 steps). The merging terrain is the terrain where the adjacent lane disappears by merging with the traveling lane. The traveling lane is a lane in which the vehicle 10 travels. The adjacent lane is a lane to which the traveling lane is adjacent. Specifically, the determination unit 232, based on the current position of the vehicle 10, the navigation route, and the map information, in the most recent driving section of the navigation route, determines whether or not there is a merging terrain. The determination unit 231 is an example of a first determination unit. The determination unit 231 may recognize an area between the merging start position and the merging end position as the merging terrain. The determination unit 231 may determine that there is a merging terrain until the vehicle 10 passes through the merging end position at which the traveling lane and the adjacent lane end to be connected.

The merging terrain includes a terrain in which another road merges into a road on which the vehicle 10 travels and disappear by merging the adjacent lane adjacent to the traveling lane with the traveling lane. As this merging terrain, there is an example shown in FIG. 1. Also, the merging terrain includes a terrain in which the adjacent lane merges with the traveling lane in the road on which the vehicle 10 travels, and thus disappears. As this merging terrain, for example, there is a terrain including a slow-vehicle lane.

If there is a merging terrain (step S101—Yes), the determination unit 231 determines whether there is a front vehicle traveling in the traveling lane ahead of the vehicle 10 based on the surrounding environmental information of the vehicle 10, within a predetermined range from the vehicle 10, (step S102). The surrounding environment information includes the object detection information. The predetermined range is a range in which the front vehicle can be detected based on the camera image or the reflected wave information by the object detecting device 13. If a front vehicle is detected, the object detection information includes the current position of the front vehicle and information representing the lane in which the front vehicle is traveling. The determination unit 231 determines whether or not there is a front vehicle based on the object detection information and the map information. This front vehicle is meant to be located in front of the vehicle 10 in the traveling lane.

If there is a front vehicle (step S102—Yes), the determination unit 231 determines whether there is an adjacent vehicle traveling in the adjacent lane based on the surrounding environmental information of the vehicle 10, within a predetermined range from the vehicle (step S103). The surrounding environment information includes the object detection information. The predetermined range is a range in which the adjacent vehicle can be detected based on the camera image or the reflected wave information by the object detecting device 13. If an adjacent vehicle is detected, the object detection information includes the current position of the adjacent vehicle and information representing the lane in which the adjacent vehicle is traveling. The determination unit 231 determines whether or not there is an adjacent vehicle based on the object detection information and the map information.

If there is an adjacent vehicle (step S103—Yes), the estimation unit 232 estimations whether or not the adjacent vehicle moves to the traveling lane ahead of the vehicle 10 in the merging terrain based on the distance L1, the distance L2, and the speed of the vehicle 10 (step S104). The distance L1 is the distance of the front vehicle with respect to the vehicle 10. The distance L2 is the distance of the adjacent vehicle with respect to the vehicle 10. The estimation unit 232 acquires the speed of the vehicle 10 based on the speed information.

The distance L1 and the distance L2 are, for example, distances along the headway of the vehicle 10. Specifically, the distance L1 is the distance between the position where the front vehicle is projected with respect to the center line of the traveling lane of the vehicle 10 and the position where the vehicle 10 is projected with respect to the center line of the traveling lane of the vehicle 10. The distance L1 may be the distance between the front end of the vehicle 10 and the rear end of the front vehicle. The estimation unit 232 obtains the distance L1 based on the position of the front vehicle, the present position of the vehicle 10, and the map information.

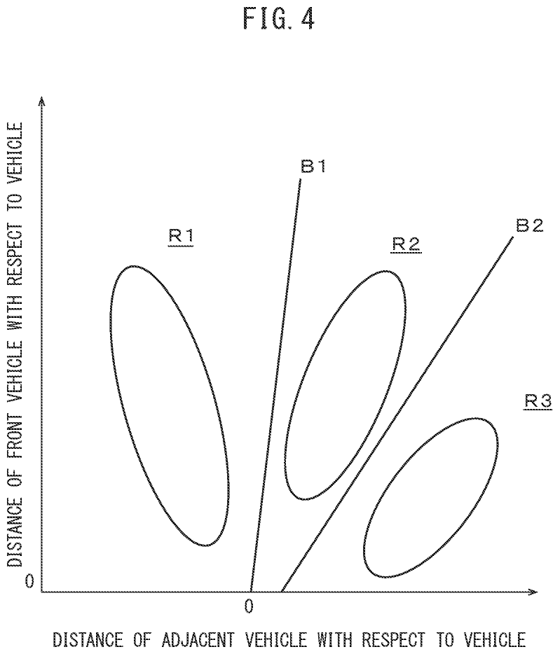

Similarly, the distance L2 is the distance between the position where the adjacent vehicle is projected with respect to the center line of the traveling lane of the vehicle 10 and the position where the vehicle 10 is projected with respect to the center line of the traveling lane of the vehicle 10. The distance L2 may be the distance between the front end of the vehicle 10 and the rear end of the adjacent vehicle. Alternatively, the distance L2 may be the distance between the rear end of the vehicle 10 and the front end of an adjacent vehicle. The estimation unit 232 obtains the distance L2 based on the position of the adjacent vehicle, the present position of the vehicle 10, and the map information. This estimation process will be described further below with reference to FIG. 4.

If it is estimated that the adjacent vehicle moves to the traveling lane ahead of the vehicle 10 (step S104—Yes), the setting unit 233 sets the first inter-vehicle distance M1 based on the distance L1, the distance L2, and the speed of the vehicle 10 (step S105), and a series of processes ends. The first inter-vehicle distance M1 is the distance between the front vehicle and the vehicle 10 on the traveling lane.

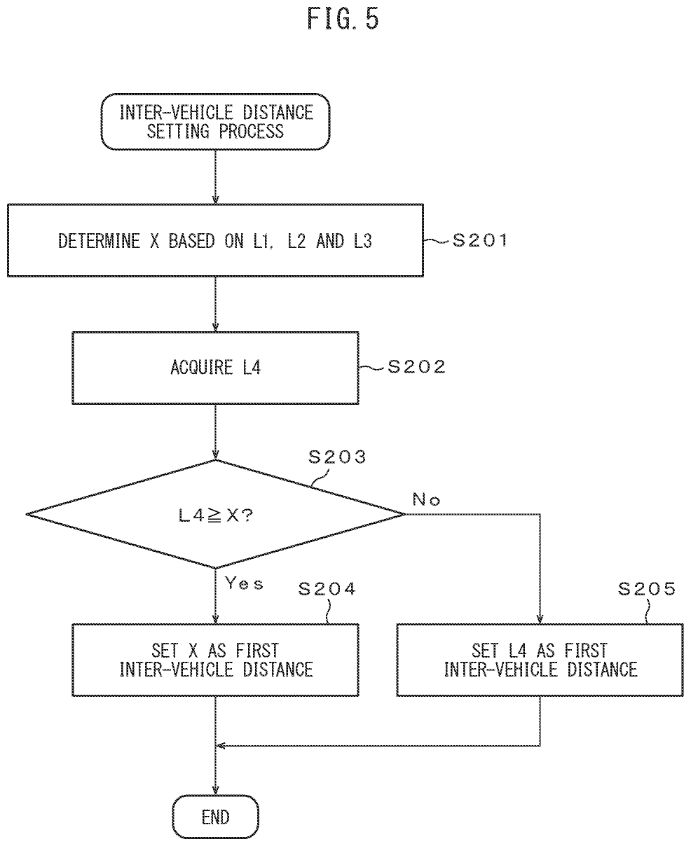

The first inter-vehicle distance M1 is, for example, the distance along the traveling direction of the vehicle 10. Specifically, the first inter-vehicle distance M1 is the distance between the position where the front vehicle is projected with respect to the center line of the traveling lane of the vehicle 10 and the position where the vehicle 10 is projected with respect to the center line of the traveling lane of the vehicle 10. The first inter-vehicle distance M1 may be the distance between the front end of the vehicle 10 and the rear end of the front vehicle. This setting process will be described further below with reference to FIGS. 5 to 8.

In the step S103 described above, when it is determined that there is a plurality of adjacent vehicles, the process of the step S104 and step S105 may be performed for each of the plurality of adjacent vehicles. In this instance, the setting unit 233 may select the largest value among the first inter-vehicle distances obtained for each of the plurality of adjacent vehicles as the first inter-vehicle distance M1 used for the operation planning.

The setting unit 233 notifies the operation planning device 15 of the first inter-vehicle distance M1 through the in-vehicle network 18. The operation planning device 15 generates an operation plan so as to maintain the first inter-vehicle distance M1 for the front vehicle.

On the other hand, if there is no merging terrain (step S101-No), if there is no front vehicle (step S102-No), if there is no adjacent vehicle (step S103-No), or if it is estimated that the adjacent vehicle does not move to the traveling lane ahead of the vehicle 10 (step S104-No), the series of processes ends.

When there is no adjacent vehicle (S103-No of steps), the setting unit 233 may set the first inter-vehicle distance M1 based on the distance L1 between the front vehicle and the vehicle 10 and the speed of the vehicle 10. Even if there is no front vehicle and the adjacent vehicle moves in front of the traveling lane, the setting unit 233 may set the inter-vehicle distance of the vehicle 10 with respect to the adjacent vehicle based on the distance between the adjacent vehicle and the vehicle 10 and the speed of the vehicle 10.

In terrain other than the merging terrain, the setting unit 233 may set the inter-vehicle distance of the vehicle 10 with respect to the front vehicle based on the distance L1 between the front vehicle and the vehicle 10 and the speed of the vehicle 10.

Next, with reference to FIG. 4, the estimation process of the estimation unit 232 will be described below. FIG. 4 is a diagram illustrating estimation processing of the inter-vehicle distance setting device 17 according to the present exemplary embodiment.

In the actual merging terrain as shown in FIG. 1, a number of relationship between the position where the adjacent vehicles moved from the adjacent lane to the traveling lane and the distance L1 and distance L2 were measured, and the data shown in FIG. 4 was acquired. In FIG. 1, the host vehicle corresponds to the vehicle 10, the adjacent vehicle corresponds to the vehicle 80, the front vehicle corresponds to the vehicle 70. Further, in FIG. 1, the traveling lane corresponds to the lane 51, the adjacent lane corresponds to the lane 61.

FIG. 4 shows the measurement results schematically. The vertical axis of FIG. 4 represents the distance L1 of the front vehicle with respect to the vehicle 10, and the horizontal axis represents the distance L2 of the adjacent vehicle with respect to the vehicle 10. The relationship shown in FIG. 4 also includes data for different speeds of the vehicle 10.

The distance L1 and distance L2 are associated with the position where the adjacent vehicle has moved from the adjacent lane to the traveling lane. Moving of the adjacent vehicle to the traveling lane includes moving of the adjacent vehicle to the front of the vehicle 10 and moving of the adjacent vehicle to the rear of the vehicle 10.

As shown in FIG. 4, the relation between the distance L1 and the distance L2 is distributed like region R1, region R2 and region R3. Here, it has been often observed in the region R2 that the adjacent vehicle moves in front of the vehicle 10. Moving of the adjacent vehicle in front of the vehicle 10 includes moving of the adjacent vehicle in front of the front vehicle and moving of the adjacent vehicle between the vehicle 10 and the front vehicle.

Therefore, an equation B1 (L1, L2, V) representing the boundary line B1 partitioning the region R1 and the region R2, and an equation B2 (L1, L2, V) representing the boundary line B2 partitioning the region R2 and the region R3 were obtained using multivariate analysis. Where V is the speed of the vehicle 10. The equations B1 (L1, L2, V) and B2 (L1, L2, V) are stored in the memory 22. As the speed of the vehicle 10, the average speed of the most recent vehicle 10 may be used.

As described below, the estimation unit 232 estimates whether or not the adjacent vehicle moves to the traveling lane ahead of the vehicle 10 by using a regression equation in which a distance L1, a distance L2, and a speed V of the vehicle 10 are variables.

The equation B1 (L1, L2, V) is expressed by the following equation (1).

$$B 1 ( L 1 , L 2 , V ) = a 1 L 1 + b 1 L 2 + c 1 V + d 1 \qquad ( 1 )$$

Here, a1, b1, c1 and d1 are parameters obtained by multivariate analysis.

The equation B2 (L1, L2, V) is expressed by the following equation (2).

$$B 2 ( L 1 , L 2 , V ) = a 2 L 1 + b 2 L 2 + c 2 V + d 2 \qquad ( 2 )$$

Here, a2, b2, c2 and d2 are parameters obtained by multivariate analysis.

Then, when the relationship of the following equation (3) is satisfied, the adjacent vehicle moves in front of the front vehicle in the traveling lane.

$$B 1 ( L 1 , L 2 , V ) \geq 0 \qquad ( 3 )$$

Further, when the relationship of the following equation (4) is satisfied, the adjacent vehicle moves between the vehicle 10 and the front vehicle.

$$B 1 ( L 1 , L 2 , V ) < 0 \qquad ( 4 )$$

When the relationship of the following equation (5) is satisfied, the adjacent vehicle moves to the rear of the front vehicle.

$$B 2 ( L 1 , L 2 , V ) \geq 0 \qquad ( 5 )$$

Further, when the relationship of the following equation (6) is satisfied, the adjacent vehicle moves between the vehicle 10 and the front vehicle.

$$B 2 ( L 1 , L 2 , V ) < 0 \qquad ( 6 )$$

Therefore, if the relationship of the following equation (7) is satisfied, the adjacent vehicle moves between the vehicle 10 and the front vehicle.

$$B 1 ( L 1 , L 2 , V ) < 0 \qquad ( 7 )$$

$$and$$

$$B 2 ( L 1 , L 2 , V ) < 0$$

The estimation unit 232 estimates whether or not the adjacent vehicle moves to the traveling lane ahead of the vehicle 10 in the merging terrain based on the distance L1, the distance L2, and the speed of the vehicle 10 according to the above-described equation (7).

Incidentally, it may be possible to estimate whether or not the adjacent vehicle moves to the traveling lane ahead of the vehicle 10 in the merging terrain by using a discriminator which is trained with the measurement result shown in FIG. 4 as the teacher data.

Next, with reference to FIGS. 5 to 8, the inter-vehicle distance setting process of the setting unit 233 will be described below. FIG. 5 is an example of an operation flowchart relating to the inter-vehicle distance setting process of the inter-vehicle distance setting device 17 of the present embodiment. The setting unit 233 executes the inter-vehicle setting process in accordance with the operation flow chart shown in FIG. 5 in the above-described step S105.

First, the setting unit 233 determines the inter-vehicle distance X between the front vehicle and the vehicle 10 on the traveling lane based on the distance L1, the distance L2 and the distance L3 (step S201). The distance L3 is a distance determined based on the relationship between the distance of the adjacent vehicle with respect to the vehicle 10 and the speed of the vehicle 10 when the adjacent vehicle moves to the traveling lane ahead of the vehicle 10.

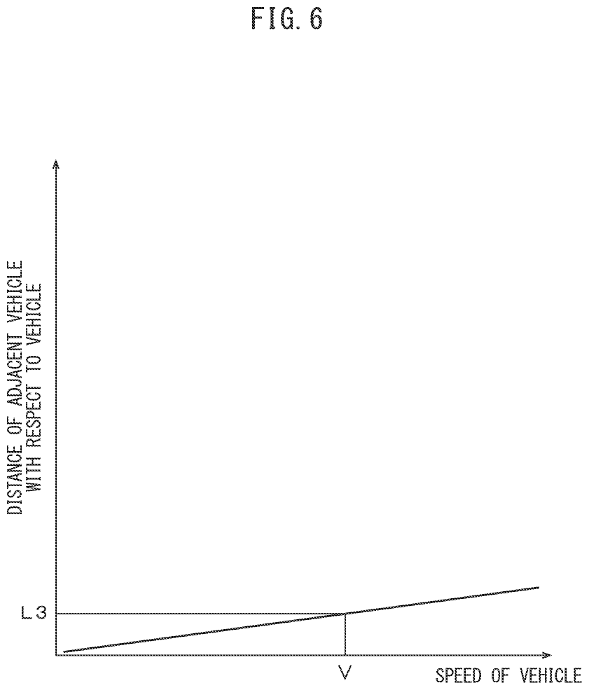

FIG. 6 is a diagram illustrating the relationship between the distance of the adjacent vehicle with respect to the vehicle 10 and the speed of the vehicle 10 when the adjacent vehicle moves to the traveling lane ahead of the vehicle 10. The relationship shown in FIG. 6 was obtained by measuring a number of relationships between the distance of the adjacent vehicle with respect to the vehicle in the traveling lane and the speed of the vehicle when the adjacent vehicle moves to the traveling lane ahead of the vehicle in the actual merging terrain as shown in FIG. 1. In FIG. 1, the host vehicle corresponds to the vehicle 10, and adjacent vehicle corresponds to the vehicle 80. Further, in FIG. 1, the traveling lane corresponds to the lane 51, the adjacent lane corresponds to the lane 61.

In the merging terrain as shown in FIG. 1, the adjacent vehicle moves to the traveling lane ahead of the vehicle 10. At this time, the driver driving the vehicle 10 sets the distance of the adjacent vehicle relative to the vehicle 10 on the traveling lane so that no significant speed change or acceleration change occurs with respect to the vehicle 10. Further, at this time, the driver driving the vehicle 10 sets the distance between the adjacent vehicle and the vehicle 10 so that the distance between the adjacent vehicle and the vehicle 10 is not too far on the traveling lane.

As shown in FIG. 6, the distance of the adjacent vehicle with respect to the vehicle 10 is proportional to the speed of the vehicle 10. In the merging terrain, the driver driving the vehicle 10 sets a distance proportional to the speed of the vehicle 10 on the traveling lane as the distance of the adjacent vehicle with respect to the vehicle 10. The distance of the adjacent vehicle with respect to the vehicle 10 is represented by the product of a predetermined factor and the speed of the vehicle 10. The distance L3 (V) is a function of the speed of the vehicle 10.

The relationship shown in FIG. 6 is stored in the memory 22. The setting unit 233 acquires the relationship illustrated in FIG. 6 from the memory 22. Based on the relationship shown in FIG. 6, the setting unit 233 acquires the distance of the adjacent vehicle with respect to the vehicle 10 corresponding to the current speed of the vehicle 10 as the distance L3. The most recent average speed of the vehicle 10 may be used as the speed of the vehicle 10.

For example, the setting unit 233 may set a value obtained by adding the distance L3 to the distance L1 of the front vehicle with respect to the vehicle 10 as the inter-vehicle distance X.

The setting unit 233 may determine the inter-vehicle distance X so that the adjacent vehicle is located between the front vehicle and the vehicle 10.

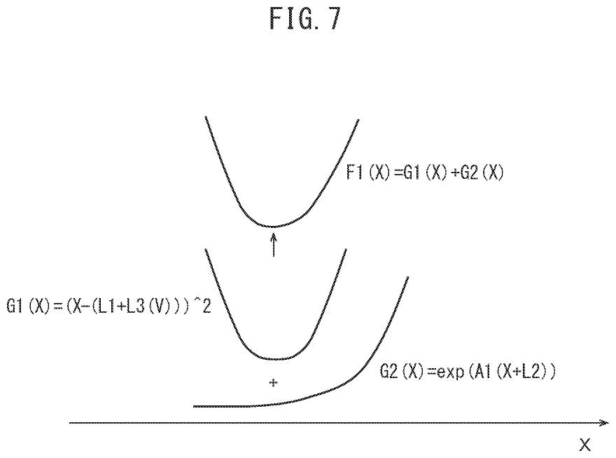

FIG. 7 is a diagram illustrating setting of an inter-vehicle distance. FIG. 7 shows that X, for which the purpose-function F1 (X) shows a minimum value, is to be found as the distance between vehicles.

The purpose-function F1 (X) is expressed by equation (8) below.

$$F 1 ( X ) = G 1 ( X ) + G 2 ( X ) \qquad ( 8 )$$

Here, each of G1 (X) and G2 (X) is expressed by the following equations (9) and (10) L1 is the distance of the front vehicle with respect to the vehicle 10. L2 is the distance of the adjacent vehicle with respect to the vehicle 10. V is the speed of the vehicle 10. A1 is a predetermined parameter. The distance L3 (V) is a distance determined based on the relationship between the distance of the adjacent vehicle with respect to the vehicle 10 and the speed of the vehicle 10 when the adjacent vehicle moves to the traveling lane ahead of the vehicle 10.

$$G 1 ( X ) = {( X - ( L 1 + L 3 ( V ) ) )}^{⋀} 2 \qquad ( 9 )$$

G1(X) specifies that the inter-vehicle distance X is set by adding the distance L3 (V) to the distance L1 of the front vehicle with respect to the vehicle 10.

$$G 2 ( X ) = exp ( A 1 ( X + L 2 ) ) \qquad ( 10 )$$

G2(X) defines that the inter-vehicle distance X is set so that the adjacent vehicle is located between the front vehicle and the vehicle 10.

X, for which the purpose-function F1 (X) shows a minimum value, is obtained, for example, using the Newtonian method.

The first inter-vehicle distance M1 is set so that the adjacent vehicle can move between the front vehicle and the vehicle 10. In addition, the first inter-vehicle distance M1 is set so that the vehicle 10 does not cause a large speed change or an acceleration change when the adjacent vehicle moves to the traveling lane. Thus, the adjacent vehicle can safely move between the vehicle 10 and the front vehicle.

The purpose-function F1 (X) may have only G1 (X). In this instance, the inter-vehicle distance X is obtained by adding the distance L3 (V) to the distance L1 of the front vehicle with respect to the vehicle 10.

Next, the setting unit 233 acquires a distance L4 that is determined based on the relationship between the distance of the front vehicle with respect to the vehicle 10 and the speed of the vehicle 10 (step S202).

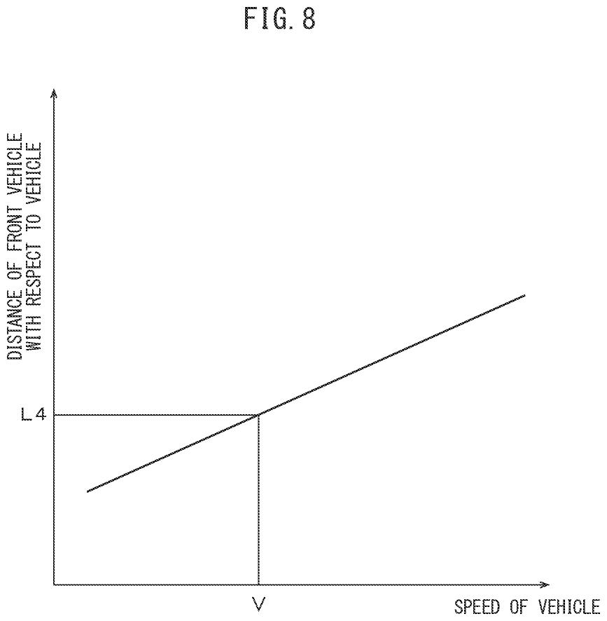

FIG. 8 is a diagram showing the relationship between the distance of the front vehicle with respect to the vehicle 10 and the speed of the vehicle 10. The relationship shown in FIG. 8 was actually obtained by measuring a number of relationships between the speed of the vehicle as it travels behind the front vehicle and the distance between the front vehicle and the vehicle on the traveling lane.

The driver driving the vehicle 10 sets the distance of the front vehicle with respect to the vehicle 10 on the traveling lane so that no significant speed or acceleration changes occur relative to the vehicle 10. Further, at this time, the driver driving the vehicle 10 sets the distance of the front vehicle with respect to the vehicle 10 on the traveling lane so that the distance between the vehicle 10 and the front vehicle is not too far.

As shown in FIG. 8, the distance of the front vehicle with respect to the vehicle 10 is proportional to the speed of the vehicle 10. The driver driving the vehicle 10 sets a distance proportional to the speed of the vehicle 10 as the distance of the front vehicle with respect to the vehicle 10 on the traveling lane. The distance of the front vehicle with respect to the vehicle 10 is represented by the product of a predetermined factor and the speed of the vehicle 10.

The relationship shown in FIG. 8 is stored in the memory 22. The setting unit 233 acquires the distance LA based on the speed of the vehicle 10 and the relationship shown in FIG. 8. The most recent average speed of the vehicle 10 may be used as the speed of the vehicle 10.

Next, the setting unit 233 determines whether the inter-vehicle distance X is equal to or less than the distance L4 (step S203). If the distance of the front vehicle with respect to the vehicle 10 is greater than the distance L4, the driver of the vehicle 10 may feel that the vehicle 10 is too far relative to the front vehicle. Therefore, in some embodiments, the first inter-vehicle distance M1 is set to be equal to or less than the distance L4.

When the inter-vehicle distance X is equal to or less than the distance L4 (step S203—Yes), the setting unit 233 sets the inter-vehicle distance X as the first inter-vehicle distance M1 (step S204), and ends a series of processes.

On the other hand, when the inter-vehicle distance X is not equal to or less than the distance L4 (Step S203—No), the setting unit 233 sets the distance LA as the first inter-vehicle distance M1 (Step S205), and ends a series of processes.

As described above, according to the inter-vehicle distance setting device of the present embodiment described in detail, an appropriate inter-vehicle distance between the host vehicle and the front vehicle can be set in the merging terrain, so that the adjacent vehicle can safely move between the host vehicle and the front vehicle.

In the above-described embodiment, the inter-vehicle distance X was compared with the distance LA. However, the inter-vehicle distance X may be set as the first inter-vehicle distance M1 without comparing with the distance L4.

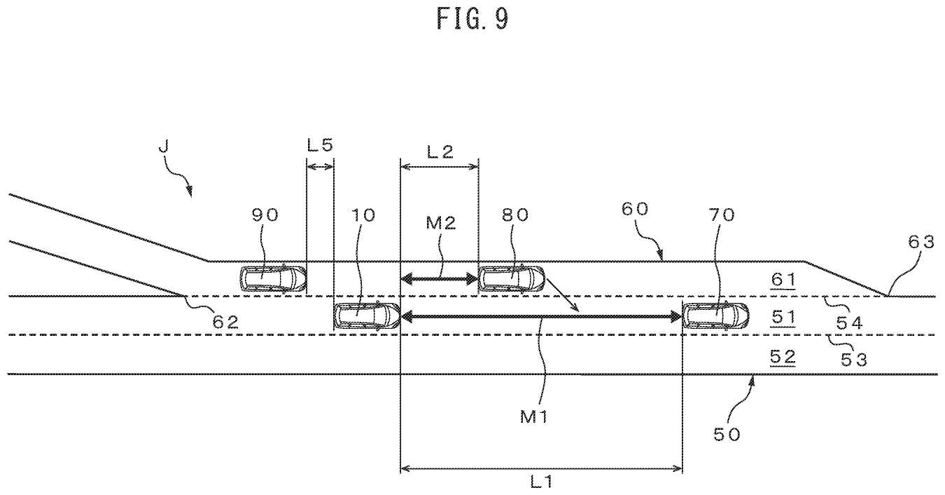

Next, a modified embodiment of the inter-vehicle distance setting device of the present embodiment described above will be described below with reference to FIGS. 9 to 11. FIG. 9 is a diagram illustrating an outline of the operation according to a modified embodiment of the inter-vehicle distance setting device 17 of the first embodiment.

FIG. 9 differs from FIG. 1 in that there is another vehicle 90 traveling behind the vehicle 80 traveling in lane 61.

If the first inter-vehicle distance M1 is longer, the vehicle 80 is likely to move between the vehicle 10 and the vehicle 70. However, if the first inter-vehicle distance M1 is too long, the vehicle 90 which travels behind the vehicle 80 is also likely to move between the vehicle 10 and the vehicle 70 together with the vehicle 80.

Therefore, in this modified embodiment, the setting unit 233 sets the first inter-vehicle distance M1 so that the length between the vehicle 70 and the vehicle 10 is such that the vehicle 90 cannot be located.

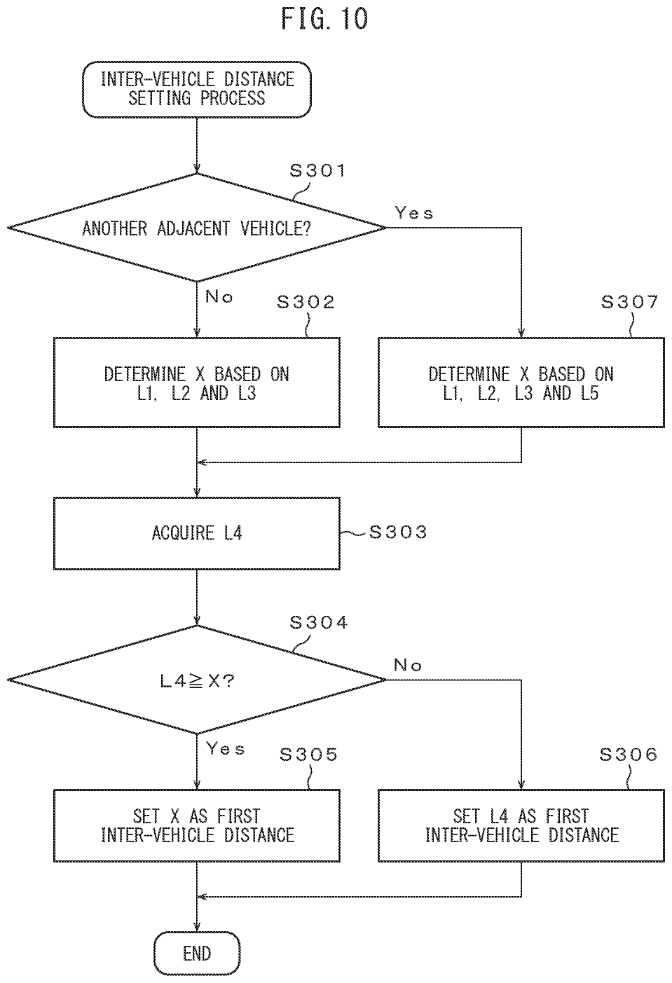

FIG. 10 is an example of an operation flowchart relating to an inter-vehicle distance setting process according to a modified embodiment of the inter-vehicle distance setting device 17 of the first embodiment. In this modified embodiment, steps S301 and S307 are added to the operation flow chart shown in FIG. 5 described above. The processing of the steps S302 to S306 is similar to the processing of steps S201 to S205 described above.

First, the determination unit 231 determines whether or not there is another adjacent vehicle traveling behind the adjacent vehicle traveling in the adjacent lane within a predetermined range from the vehicle 10 based on the surrounding environmental information of the vehicle 10 (Step S301). The surrounding environment information includes the object detection information. The predetermined range is a range in which the object detecting device 13 can detect another adjacent vehicle based on the camera image or the reflected wave information. If another adjacent vehicle is detected, the object detection information includes the current position of another adjacent vehicle and information representing the lane in which another adjacent vehicle is traveling. The determination unit 231 determines whether or not there is another adjacent vehicle based on the object detection information and the map information.

If there is another adjacent vehicle (step S301—Yes), the setting unit 233 obtains the inter-vehicle distance X between the front vehicle and the vehicle 10 on the traveling lane, based on the distance L1, distance L2, distance L3 (V) and distance L5, (step S307).

The distance L5 is the distance of another adjacent vehicle traveling behind the adjacent vehicle with respect to the vehicle 10. The distance L5 is the distance between the position where another adjacent vehicle is projected with respect to the center line of the traveling lane of the vehicle 10 and the position where the vehicle 10 is projected with respect to the center line of the traveling lane of the vehicle 10. The distance L5 may be the distance between the rear end of the vehicle 10 and the front end of another adjacent vehicle.

Alternatively, the distance L5 may be the distance between the front end of the vehicle 10 and the rear end of another adjacent vehicle. The setting unit 233 obtains the distance L5 based on the positions of another adjacent vehicle, the present position of the vehicle 10, and the map information.

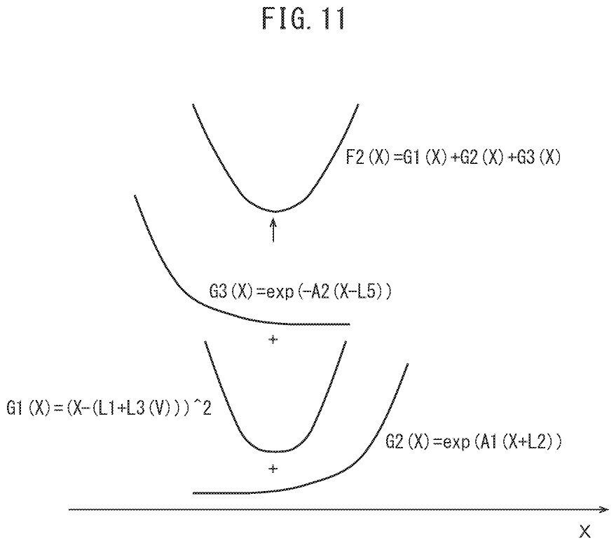

FIG. 11 is a diagram illustrating setting an inter-vehicle distance. FIG. 11 shows that X, for which the purpose-function F2(X) shows a minimum value, is to be found as the inter-vehicle distance.

The purpose-function F2(X) is expressed by the following equation (11).

$$F 2 ( X ) = G 1 ( X ) + G 2 ( X ) + G 3 ( X ) \qquad ( 11 )$$

Here, each of G1(X) and G2 (X) is represented by the above equations (9) and (10) G3 (X) is expressed by the following equation (12). A2 is a predetermined parameter.

$$G 3 ( X ) = exp ( - A 2 ( X - L 5 ) ) \qquad ( 12 )$$

X, for which the purpose-function F2(X) shows a minimum value, is obtained, for example, using the Newtonian method. Then, the process proceeds to S303 of steps.

On the other hand, if there are not another adjacent vehicle (step S301-No), the process proceeds to step S302. Other processes are the same as those of the first embodiment described above.

According to the inter-vehicle distance setting device of the present modified embodiment, the first inter-vehicle distance can be set so that another adjacent vehicle traveling behind the adjacent vehicle dose not move between the vehicle and the front vehicle. Note that F2(X) may be a sum of G1(X) and G3(X) That is, the setting unit 233 sets the first distance M1 based on the distance L1, the distance L5, and the speed of the vehicle 10, so that the length between the front vehicle and the vehicle 10 is such that another adjacent vehicle can not be located.

Next, a second embodiment of the inter-vehicle distance setting device will be described below with reference to FIGS. 1 and 12 to 14. With respect to the second embodiment, for points not specifically explained, the explanation detailed above with respect to the first embodiment applies as appropriate.

FIG. 1 is a diagram for explaining an outline of the operation of the inter-vehicle distance setting device 17 of the second embodiment. Hereinafter, with reference to FIG. 1, an outline of the operation related to the vehicle control processing of the inter-vehicle distance setting device 17 of the second embodiment disclosed herein will be described.

As shown in FIG. 1, the vehicle 10 is traveling on a lane 51 of a road 50 having lanes 51, 52 in the merging terrain J.

The inter-vehicle distance setting device 17 determines that there is a vehicle 70 which travels in a lane 51 ahead of the vehicle 10 within a predetermined range from the vehicle 10 based on information acquired by a sensor such as a camera 2a.

In addition, the inter-vehicle distance setting device 17 determines that there is a vehicle 80 traveling in the lane 61 of the road 60 within a predetermined range from the vehicle 10 based on information acquired by a sensor such as a camera 2a.

The inter-vehicle distance setting device 17 estimates that the vehicle 80 moves to the lane 51 in front of the vehicle 10. The inter-vehicle distance setting device 17 sets the second inter-vehicle distance M2 between the vehicle 80 and the vehicle 10 on the lane 51 based on the distance L1 of the vehicle 70 with respect to the vehicle 10 and the speed of the vehicle 10.

In some embodiments, the inter-vehicle distance setting device 17 sets the second inter-vehicle distance M2 so that a large speed change or acceleration change does not occur with respect to the vehicle 10. The operation planning device 15 generates an operation plan such that the second inter-vehicle range M2 between the vehicle 80 and the vehicle 10 is maintained.

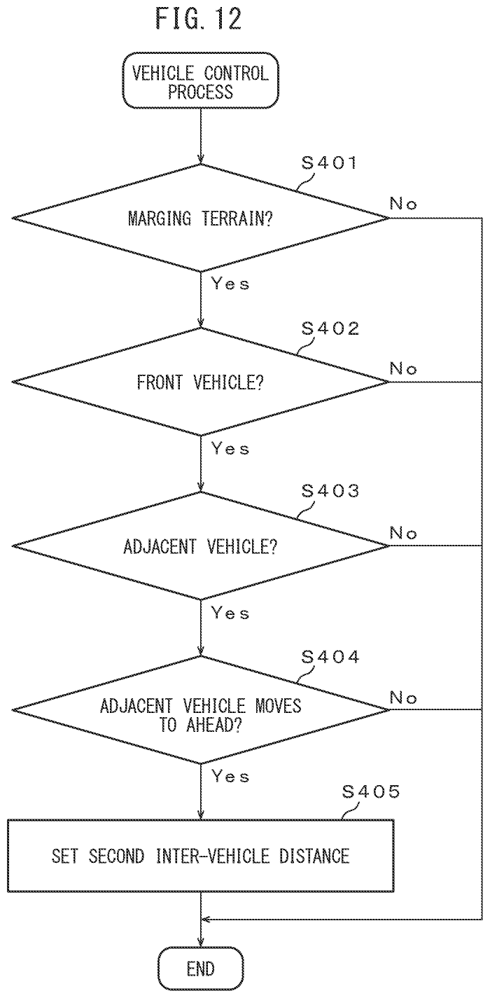

FIG. 12 is an example of an operation flowchart relating to the vehicle control processing of the inter-vehicle distance setting device 17 of the present embodiment. Referring to FIG. 12, the vehicle control processing of the inter-vehicle distance setting device 17 will be described below. The inter-vehicle distance setting device 17, at the vehicle control time having a predetermined period, executes the vehicle control processing in accordance with the operation flowchart shown in FIG. 12.

In the operation flow chart of FIG. 12, the processing of the steps S401 to S404 is similar to the processing of the steps S101 to S104 of FIG. 3 described above.

In the present embodiment, when it is estimated that the adjacent vehicle moves to the traveling lane ahead of the vehicle 10 (step S404—Yes), the setting unit 233 sets the second inter-vehicle distance M2 based on the distance L1 and the speed of the vehicle 10 (Step S405), and a series of processes ends. The distance L1 is the distance of the front vehicle with respect to the vehicle 10. The second inter-vehicle distance M2 is the distance between the adjacent vehicle and the vehicle 10 on the traveling lane.

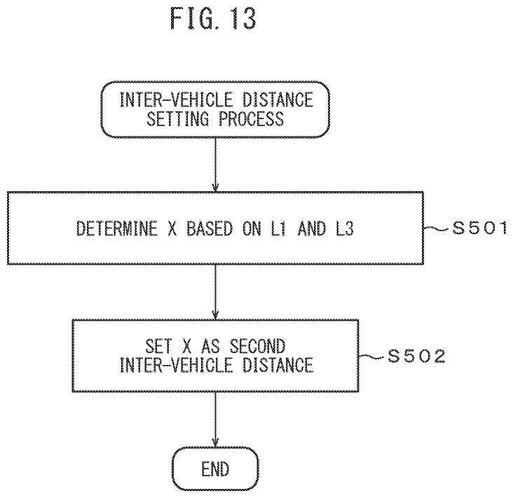

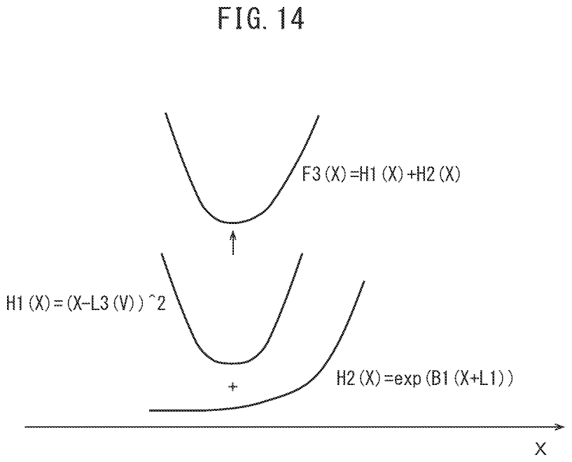

The second inter-vehicle distance M2 is, for example, the distance along the traveling direction of the vehicle 10. Specifically, the second inter-vehicle distance M2 is the distance between the position where the adjacent vehicle is projected with respect to the center line of the traveling lane of the vehicle 10 and the position where the vehicle 10 is projected with respect to the center line of the traveling lane of the vehicle 10. The second inter-vehicle distance M2 may be the distance between the front end of the vehicle 10 and the rear end of the adjacent vehicle. This setting process will be described further below with reference to FIGS. 13 and 14.

On the other hand, if there is no merging terrain (step S401-No), if there is no front vehicle (step S402-No), if there is no adjacent vehicle (step S403-No), or if it is estimated that the adjacent vehicle does not move to the traveling lane ahead of the vehicle 10 (step S404-No), the series of processes ends.

The setting unit 233 notifies the operation planning device 15 of the second inter-vehicle distance M2 through the in-vehicle network 18. The operation planning device 15 generates an operation plan so as to maintain the second inter-vehicle range M2 for the adjacent vehicle from the point before the adjacent vehicle moves to the traveling lane. The operation planning device 15 also generates an operation plan so as to maintain the second inter-vehicle distance M2 for the adjacent vehicle that has moved to the traveling lane.

The second inter-vehicle distance M2 is set so that the adjacent vehicle can move between the front vehicle and the vehicle 10. In addition, the second inter-vehicle distance M2 is set so that the vehicle 10 does not cause a large speed change or an acceleration change when the adjacent vehicle moves to the traveling lane. Thus, the adjacent vehicle can safely move between the vehicle 10 and the front vehicle.

In the step S403 described above, when it is determined that there is a plurality of adjacent vehicles, the process of the step S404 and step S405 may be performed for each of the plurality of adjacent vehicles. In this case, the setting unit 233 notifies the second vehicle distance M2 calculated for each of the plurality of adjacent vehicles and the vehicle identification information representing the adjacent vehicles to the operation planning device 15 via the in-vehicle network 18. The operation planning device 15 generates an operation plan using the second distance M2 according to the adjacent vehicle that has moved in the immediate front of the vehicle 10. The operation planning device 15 generates an operation plan so as to maintain the second inter-vehicle distance M2 for the adjacent vehicle.

FIG. 13 is an example of an operation flowchart relating to an inter-vehicle distance setting process of the inter-vehicle distance setting device 17 according to the present embodiment. The setting unit 233 executes the inter-vehicle distance setting process in accordance with the operation flow chart shown in FIG. 13 in the above-described step S405.

First, the setting unit 233 determines the inter-vehicle distance X between the adjacent vehicle and the vehicle 10 on the traveling lane based on the distance L1 and the distance L3 (V) (S501 steps). The distance L1 is the distance of the front vehicle with respect to the vehicle 10.

As shown in FIG. 6, the setting unit 233 may determine the distance L3 based on the relation between the distance of the adjacent vehicle to the vehicle 10 and the speed of the vehicle 10 when the adjacent vehicle moves to the traveling lane ahead of the vehicle 10 and the speed of the vehicle 10.

The relationship shown in FIG. 6 is stored in the memory 22. The setting unit 233 acquires the relationship illustrated in FIG. 6 from the memory 22. The setting unit 233 acquires the distance L3 (V) of the adjacent vehicle with respect to the vehicle 10 corresponding to the speed of the present vehicle 10 based on the relation shown in FIG. 6. The most recent average speed of the vehicle 10 may be used as the speed of the vehicle 10.

The setting unit 233 may determine the inter-vehicle distance X so that the adjacent vehicle is located between the front vehicle and the vehicle 10.

FIG. 14 is a diagram illustrating setting an inter-vehicle distance. FIG. 14 shows that X, for which the purpose-function F3 (X) shows a minimum value, is to be found as the inter-vehicle distance. X, for which the purpose-function F3 (X) shows a minimum value, is obtained, for example, using the Newtonian method.

$$F 3 ( X ) = H 1 ( X ) + H 2 ( X ) \qquad ( 13 )$$

Here, each of H1 (X) and H2 (X) is expressed by the following equations (14) and (15) L1 is the distance of the front vehicle with respect to the vehicle 10. V is the speed of the vehicle 10. B1 is a predetermined parameter. L3 is a distance determined based on the relationship between the distance of the adjacent vehicle with respect to the vehicle 10 and the speed of the vehicle 10 and the speed of the vehicle 10 when the adjacent vehicle moves to the traveling lane ahead of the vehicle 10.

$$H 1 ( X ) = {( X - L 3 ( V ) )}^{⋀} 2 \qquad ( 14 )$$

H1(X) specifies that the distance L3 is set as the inter-vehicle distance X.

$$H 2 ( X ) = exp ( B 1 ( X + L 1 ) ) \qquad ( 15 )$$

H2(X) defines that the inter-vehicle distance X is set so that the adjacent vehicle is located between the front vehicle and the vehicle 10.

The purpose-function F3(X) may have only H1(X). In this case, the inter-vehicle distance X is a distance determined based on the relationship between the distance of the adjacent vehicle with respect to the vehicle 10 and the speed of the vehicle 10 and the speed of the vehicle 10 when the adjacent vehicle moves to the traveling lane ahead of the vehicle 10.

Next, the setting unit 233 sets the inter-vehicle distance X as the second inter-vehicle distance M2 (step S502) and ends the series of processes.

The setting unit 233 may set the second inter-vehicle distance M2 by comparing the inter-vehicle distance X with the distance L4 determined based on the relationship between the distance of the front vehicle with respect to the vehicle 10 and the speed of the vehicle 10, similarly to the inter-vehicle distance setting process shown in FIG. 5. Thus, the setting unit 233 can set the second inter-vehicle distance M2 so that the driver of the vehicle 10 does not feel that the vehicle 10 is too far from the adjacent vehicle.

As described above, according to the inter-vehicle distance setting device of the present embodiment, an appropriate inter-vehicle distance between the host vehicle and the adjacent vehicle can be set in the merging terrain, so that the adjacent vehicle can safely move between the host vehicle and the front vehicle.

Next, a modified embodiment of the inter-vehicle distance setting device of the above-described second embodiment will be described below with reference to FIGS. 9, 15, and 16. FIG. 9 is a diagram illustrating an outline of the operation of a variant of the inter-vehicle distance setting device 17 according to the second embodiment.

FIG. 9 differs from FIG. 1 in that there is another vehicle 90 traveling behind the vehicle 80 traveling in lane 61.

If the second inter-vehicle distance M2 is longer, the vehicle 80 easily moves to the lane 51 at a distance from the vehicle 10. However, if the second inter-vehicle distance M2 is too long, together with the vehicle 80, the vehicle 90 traveling behind the vehicle 80 may also move to the lane 51 in front of the vehicle 10.

Therefore, in this modified embodiment, the setting unit 233 sets the second inter-vehicle distance M2 so that the length between the vehicle 80 and the vehicle 10 is such that the vehicle 90 cannot be located.

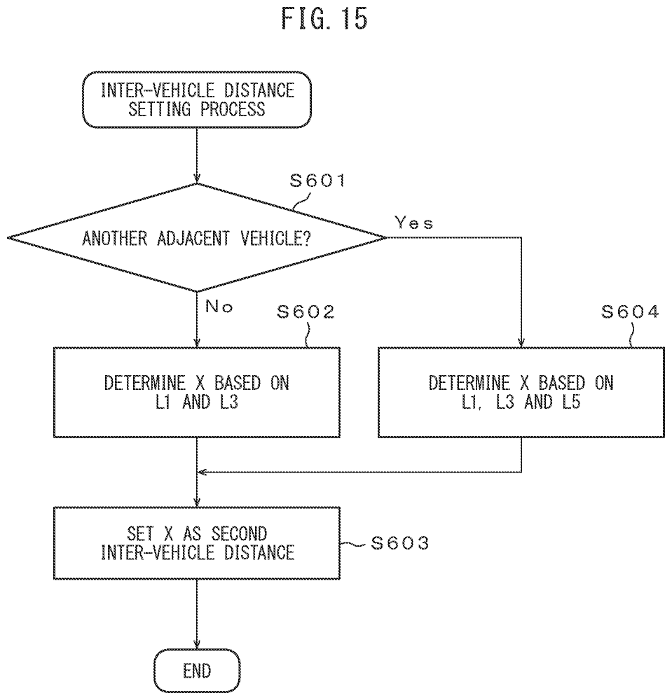

FIG. 15 is an example of an operation flowchart relating to an inter-vehicle distance setting process according to a modified embodiment of the inter-vehicle distance setting device 17 of the second embodiment. In this variation, steps S601 and S604 have been added to the operational flow chart shown in FIG. 13 described above. The processing of the steps S602 and S603 is similar to the processing of the steps S501 and S502 described above.

First, the determination unit 231 determines whether or not there is another adjacent vehicle traveling behind the adjacent vehicle traveling in the adjacent lane within a predetermined range from the vehicle 10 based on the surrounding environmental information of the vehicle 10 (Step S601). The surrounding environment information includes the object detection information. The predetermined range is a range in which the object detecting device 13 can detect another adjacent vehicle based on the camera image or the reflected wave information. If another adjacent vehicle is detected, the object detection information includes the current position of another adjacent vehicle and information representing the lane in which another adjacent vehicle is traveling. The determination unit 231 determines whether or not there is another adjacent vehicle based on the object detection information and the map information.

When there is another adjacent vehicle (step S601—Yes), the setting unit 233 determines the inter-vehicle distance X between the adjacent vehicle and the vehicle 10 on the traveling lane based on the distance L1, the distance L3, and the distance L5 (step S604).

The distance L5 is the distance of another adjacent vehicle traveling behind the adjacent vehicle with respect to the vehicle 10. The distance L5 is the distance between the position where another adjacent vehicle is projected with respect to the center line of the traveling lane of the vehicle 10 and the position where the vehicle 10 is projected with respect to the center line of the traveling lane of the vehicle 10. The distance L5 may be the distance between the rear end of the vehicle 10 and the front end of another adjacent vehicle.

Alternatively, the distance L5 may be the distance between the front end of the vehicle 10 and the rear end of another adjacent vehicle. The setting unit 233 obtains the distance L5 based on the position of another adjacent vehicle, the present position of the vehicle 10, and the map information.

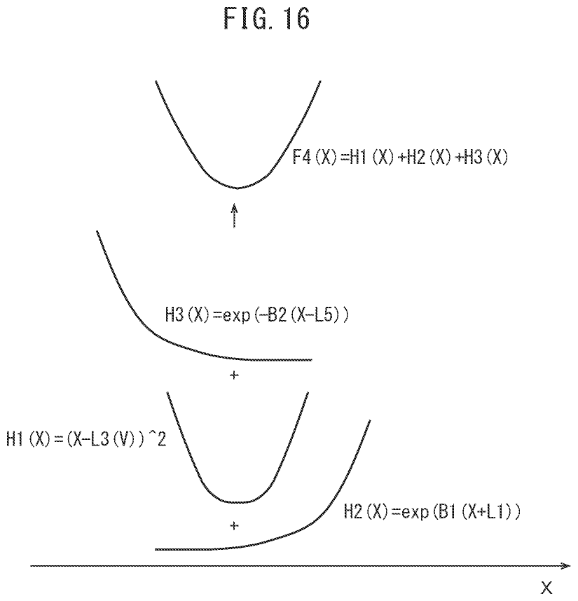

FIG. 16 is a diagram illustrating setting an inter-vehicle distance. FIG. 16 shows that X, for which the purpose-function F4 (X) shows a minimum value, is to be found as the inter-vehicle distance.

The purpose-function F4 (X) is expressed by the following equation (16).

$$F 4 ( X ) = H 1 ( X ) + H 2 ( X ) + H 3 ( X ) \qquad ( 16 )$$

Here, each of H1 (X) and H2 (X) is represented by the above formulas (14) and (15) H3 (X) is expressed by the following formula (17) B2 is a predetermined parameter.

$$H 3 ( X ) = exp ( - B 2 ( X - L 5 ) ) \qquad ( 17 )$$

X, for which the purpose-function F4 (X) shows a minimum value, is obtained, for example, using the Newtonian method. Then, the process proceeds to step S603.

On the other hand, if there are no other adjacent vehicles (step S601-No), the process proceeds to step S602. Other processes are the same as those of the second embodiment described above.

According to the inter-vehicle distance setting device of the present modified embodiment, the second inter-vehicle distance can be set so that another adjacent vehicle traveling behind the adjacent vehicle traveling in the adjacent lane does not move in front of the vehicle. Note that F4 (X) may be a sum of H1 (X) and H3 (X) That is, the setting unit 233 sets the second distance M2 based on the distance L5 and the speed of the vehicle 10, so that the length between the front vehicle and the vehicle 10 is such that another adjacent vehicle cannot be located.

In the present disclosure, the vehicle control device of the embodiment described above, a computer program for controlling a vehicle and a method for controlling a vehicle can be changed as appropriate without departing from the scope of the present disclosure. Further, the technical scope of the present disclosure is not limited to those embodiments, but extends to the present disclosure described in the claims and the equivalent thereof.

For example, the setting unit 233 may set the first inter-vehicle distance M1 when the distance L1 of the front vehicle with respect to the vehicle 10 is equal to or less than a predetermined reference distance Ma, and set the second inter-vehicle distance M2 when the speed of the vehicle 10 exceeds this reference distance Ma.

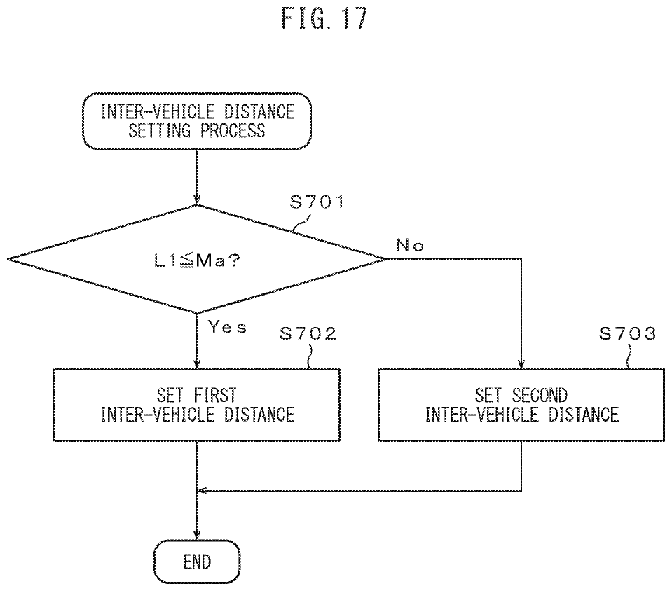

FIG. 17 is a diagram illustrating another inter-vehicle distance setting process of the setting unit 233. In step S105 shown in FIG. 3 described above, the setting unit 233 performs the inter-vehicle distance setting process according to the operation flow chart shown in FIG. 17.

First, the setting unit 233 determines whether the distance L1 of the front vehicle with respect to the vehicle 10 is equal to or less than the reference distance Ma (step S701). As the reference distance Ma, it can be an inter-vehicle distance in which it is determined whether the traveling lane is congested or not.

If the distance L1 is equal to or less than the reference distance Ma (step S701—Yes), the setting unit 233 sets the first inter-vehicle distance M1 (step S702), and ends the series of processes.

On the other hand, if the distance L1 exceeds the reference distance Ma (step S701—No), the setting unit 233 sets the second inter-vehicle distance M2 (step S703), and ends the series of processes.

If the road is congested, the vehicle 10 is stopped or moving. Therefore, when the road is congested, even though the instantaneous speed of the vehicle 10 can be detected, in the meaning that the speed representing the running state of the vehicle 10, there is a possibility that the speed of the vehicle 10 cannot be accurately detected.

On the other hand, the distance between the vehicle 10 and the front vehicle and the distance between the vehicle 10 and the adjacent vehicle can be detected relatively accurately even when the road is congested.

Therefore, in some embodiments, when the distance L1 is equal to or less than the reference distance Ma, the first inter-vehicle distance M1 is set for the front vehicle, which is closer to the vehicle 10. Thus, safety of the adjacent vehicle, the front vehicle and the vehicle 10 is ensured.

Also, if the road is not congested, the speed of the vehicle 10 traveling is relatively accurately detectable. Setting the second inter-vehicle distance M2 so that the adjacent vehicle can move in the traveling lane leads to ensuring the safety of the adjacent vehicle, front vehicle and vehicle 10.

Therefore, in some embodiments, when the distance L1 exceeds the reference distance Ma, the second inter-vehicle distance M2 is set so that the adjacent vehicle can move in the traveling lane. Thus, for the adjacent vehicle attempting to move in the traveling lane, the vehicle 10 is controllable to maintain the second inter-vehicle M2.

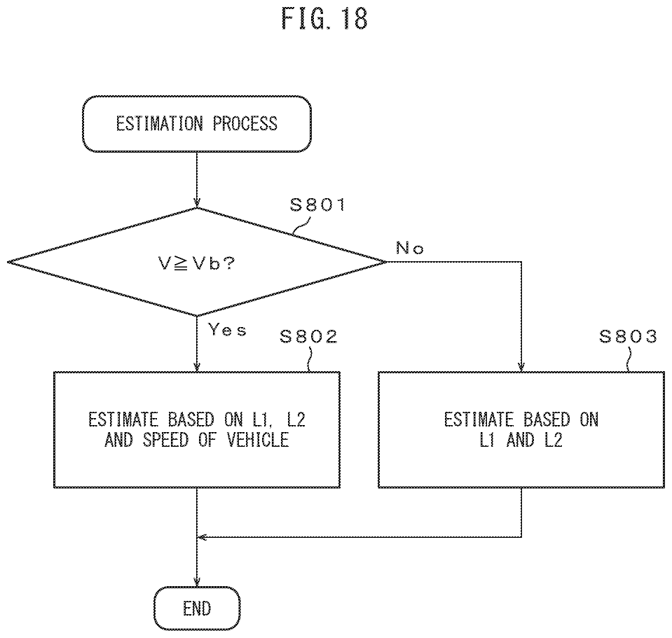

FIG. 18 is a diagram for explaining another estimation process of the estimation unit 232. The estimation unit 232 executes the estimation process in accordance with the operation flow chart shown in FIG. 18 in step S104 shown in FIG. 3 described above.

First, the estimation unit 232 determines whether or not the absolute value of the relative speed of the adjacent vehicle with respect to the vehicle 10 is equal to or more than a predetermined reference speed Vb (step S801). The reference speed Vb is an example of the first reference speed. The estimation unit 232 acquires the speed of the adjacent vehicle based on the object detection information. The estimation unit 232 determines the absolute value of the difference between the speed of the vehicle 10 and the speed of the adjacent vehicle.

When the absolute value of the relative speed is equal to or greater than the reference speed Vb (step S801—Yes), the estimation unit 232 estimations whether or not the adjacent vehicle moves to the traveling lane ahead of the vehicle 10 in the merging terrain based on the distance L1, the distance L2, and the speed of the vehicle 10, and terminates the series of processes (step S802). The distance L1 is the distance of the front vehicle with respect to the vehicle 10. The distance L2 is the distance of an adjacent vehicle with respect to the vehicle 10.

On the other hand, when the absolute value of the relative speed is less than the reference speed Vb (step S801-No), the estimation unit 232 estimations whether or not the adjacent vehicle moves to the traveling lane ahead of the vehicle 10 in the merging terrain based on the distance L1 and the distance L2 (step S803), and ends the series of processes.

The estimation unit 232 may estimate whether or not the adjacent vehicle moves to the traveling lane ahead of the vehicle 10 by using a regression equation in which the distance L1 and the distance L2 are variables. This regression equation can be obtained by measuring the actual data shown in FIG. 4 in the merging terrain.

Further, it may be possible to estimate whether or not the adjacent vehicle moves to the traveling lane ahead of the vehicle 10 in the merging terrain based on the distance L1 and the distance L2 by using a discriminator which is trained by the measured result as shown in FIG. 4 as the teacher data.

If the absolute speed is less than the reference speed Vb, the street is estimated to be congested. If the road is congested, the vehicle 10 is stopped or moving. Therefore, when the road is congested, even if the instantaneous speed of the vehicle 10 can be detected, in the meaning that the speed representing the running state of the vehicle 10, there is a possibility that the speed of the vehicle 10 cannot be accurately detected.

Therefore, when the absolute value of the relative speed is less than the reference speed Vb, the estimation unit 232 performs the estimation process without using the speed of the vehicle 10. This prevents the wrong estimation process from being performed.

On the other hand, if the absolute value of the relative speed is equal to or greater than the reference speed Vb, the speed of the vehicle 10 is also used to perform the estimation process more accurately.

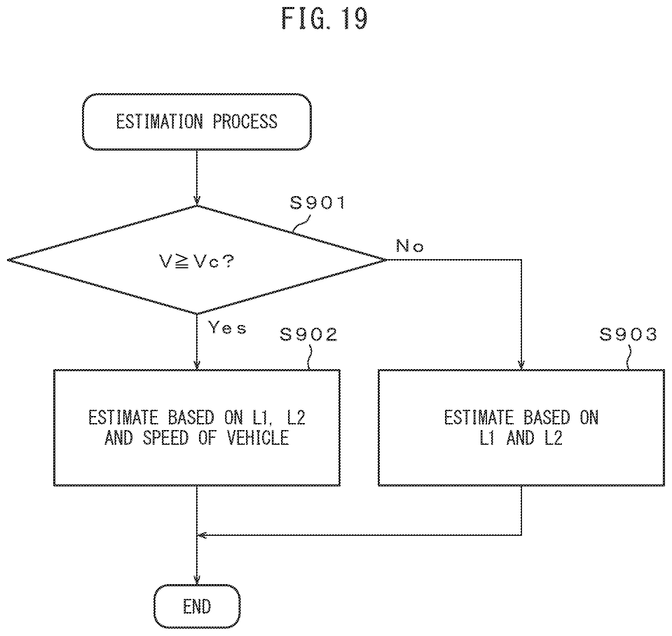

FIG. 19 is a diagram illustrating still another estimation process of the estimation section 232. The estimation unit 232 executes the estimation process according to the operation flow chart shown in FIG. 19 in the step S104 shown in FIG. 3 described above.

First, the estimation unit 232 determines whether the speed V of the vehicle 10 is equal to or more than a predetermined reference speed Vc (step S901). The reference speed Vc is an example of the second reference speed.

When the speed V of the vehicle 10 is equal to or greater than the reference speed Vc (step S901—Yes), the estimation unit 232 estimates whether or not the adjacent vehicle moves to the traveling lane ahead of the vehicle 10 in the merging terrain based on the distance L1, the distance L2, and the speed of the vehicle 10 (step S902), and ends a series of processes. The distance L1 is the distance of the front vehicle with respect to the vehicle 10. The distance L2 is the distance of the adjacent vehicle to the vehicle 10.

On the other hand, when the vehicle 10 speed V is less than the reference speed Vc (step S901—No), the estimation unit 232 estimations whether or not the adjacent vehicle moves to the traveling lane ahead of the vehicle 10 in the merging terrain based on the distance L1 and the distance L2, and (step S903) ends a series of processes.

The estimation unit 232 estimates whether or not the adjacent vehicle moves to the traveling lane ahead of the vehicle 10 by using a regression equation in which the distance L1 and the distance L2 are variables. This regression equation can be obtained by measuring the actual data shown in FIG. 4 in the merging terrain.

Further, it may be possible to estimate whether or not the adjacent vehicle moves to the traveling lane ahead of the vehicle 10 in the merging terrain based on the distance L1 and the distance L2 by using a discriminator which is trained by the measured result as shown in FIG. 4 as the teacher data.

If the road is congested, the vehicle 10 is stopped or moving. Therefore, if the lane is congested, even though the instantaneous speed of the vehicle 10 can be detected, in the meaning that the speed representing the running state of the vehicle 10, there is a possibility that it can not be accurately detected.

Therefore, when the speed V of the vehicle 10 is less than the reference speed Vb, the estimation unit 232 performs the estimation process without using the speed of the vehicle 10. This prevents the wrong estimation process from being performed.

On the other hand, if the speed V of the vehicle 10 is equal to or greater than the reference speed Vb, the speed of the vehicle 10 is also used to perform the estimation process more accurately.

Addendum is described here.

### APPENDIX 1

A vehicle control device comprising:
a processor configured to
   determine whether there is a merging terrain where an adjacent lane adjacent to a traveling lane in which a host vehicle is traveling disappears by merging with the traveling lane within a first predetermined range from a current position of the host vehicle toward a traveling direction based on map information,
   determine whether there is a front vehicle traveling in the traveling lane ahead of the host vehicle within a second predetermined range from the host vehicle and determine whether there is an adjacent vehicle traveling in the adjacent lane within a third predetermined range from the host vehicle based on surrounding environment information of the host vehicle, when it has been determined that there is the merging terrain,
   estimate whether the adjacent vehicle moves into the traveling lane ahead of the host vehicle in the merging terrain based on distance of the front vehicle with respect to the host vehicle, distance of the adjacent vehicle with respect to the host vehicle, and speed of the host vehicle, when it has been determined that there is the front vehicle and there is the adjacent vehicle, and
   set a first inter-vehicle distance between the front vehicle and the host vehicle in the traveling lane based on the distance of the front vehicle with respect to the host vehicle and the speed of the host vehicle or set a second inter-vehicle distance between the adjacent vehicle and the host vehicle in the traveling lane based on the speed of the host vehicle, when it has been estimated that the adjacent vehicle moves into the traveling lane ahead of the host vehicle.

### APPENDIX 2

The vehicle control device according to Appendix 1, wherein the processor is further configured to set a value obtained by adding the distance of the front vehicle with respect to the host vehicle with a distance determined based on the relationship between the distance of the adjacent vehicle with respect to the host vehicle and the speed of the vehicle when the adjacent vehicle moves into the traveling lane ahead of the host vehicle, as the first inter-vehicle distance.

### APPENDIX 3

The vehicle control device according to Appendix 2, wherein the processor is further configured to set the first inter-vehicle distance so that the adjacent vehicle is positioned between the front vehicle and the host vehicle.

### APPENDIX 4

The vehicle control device according to Appendix 2, wherein the processor is further configured to
determine whether there is another adjacent vehicle traveling behind the adjacent vehicle in the adjacent lane within a fourth predetermined range from the host vehicle, and
set the first inter-vehicle distance to be a length at which another adjacent vehicle cannot be located between the front vehicle and the host vehicle based on the distance of the front vehicle with respect to the host vehicle, distance of another adjacent vehicle with respect to the host vehicle and the speed of the host vehicle, when it has been determined that there is another adjacent vehicle and it is estimated that the adjacent vehicle moves into the traveling lane ahead of the host vehicle.

### APPENDIX 5

The vehicle control device according to Appendix 2, wherein the processor is further configured to set the first inter-vehicle distance equal to or below a length determined based on the relationship between the distance of the front vehicle with respect to the host vehicle and the speed of the host vehicle.

### APPENDIX 6

The vehicle control device according to Appendix 1, wherein the processor is further configured to estimate whether the adjacent vehicle moves into the traveling lane ahead of the host vehicle using a regression equation in which the distance of the front vehicle with respect to the host vehicle, the distance of the adjacent vehicle with respect to the host vehicle and the speed of the vehicle are variables.

### APPENDIX 7

The vehicle control device according to Appendix 1, wherein the processor is further configured to set a length determined based on the relationship between the distance of the adjacent vehicle with respect to the host vehicle and the speed of the host vehicle when the adjacent vehicle moves into the traveling lane ahead of the host vehicle, as the second inter-vehicle distance.

### APPENDIX 8

The vehicle control device according to Appendix 1, wherein the processor is further configured to set the second inter-vehicle distance so that the adjacent vehicle is positioned between the front vehicle and the host vehicle.

### APPENDIX 9

The vehicle control device according to Appendix 1, wherein the processor is further configured to
determine whether there is another adjacent vehicle traveling behind the adjacent vehicle in the adjacent lane within a fifth predetermined range from the host vehicle, and
set the second inter-vehicle distance to be a length at which another adjacent vehicle cannot be located between the front vehicle and the host vehicle based on distance of another adjacent vehicle with respect to the host vehicle and the speed of the host vehicle, when it has been determined that there is another adjacent vehicle and it is estimated that the adjacent vehicle moves into the traveling lane ahead of the host vehicle.

### APPENDIX 10

The vehicle control device according to Appendix 1, wherein the processor is further configured to
estimate whether the adjacent vehicle moves into the traveling lane ahead of the host vehicle in the merging terrain based on the distance of the front vehicle with respect to the host vehicle, the distance of the adjacent vehicle with respect to the host vehicle, and speed of the host vehicle, when an absolute value of relative speed of the adjacent vehicle with respect to the host vehicle is equal to or above a first reference speed, and
estimate whether the adjacent vehicle moves into the traveling lane ahead of the host vehicle in the merging terrain based on the distance of the front vehicle with respect to the host vehicle and the distance of the adjacent vehicle with respect to the host vehicle, when the absolute value of relative speed of the adjacent vehicle with respect to the host vehicle is less than the first reference speed.

### APPENDIX 11

The vehicle control device according to Appendix 1, wherein the processor is further configured to
estimate whether the adjacent vehicle moves into the traveling lane ahead of the host vehicle in the merging terrain based on the distance of the front vehicle with respect to the host vehicle, the distance of the adjacent vehicle with respect to the host vehicle, and speed of the host vehicle, when the speed of the host vehicle is equal to or above a second reference speed, and
estimate whether the adjacent vehicle moves into the traveling lane ahead of the host vehicle in the merging terrain based on the distance of the front vehicle with respect to the host vehicle and the distance of the adjacent vehicle with respect to the host vehicle, when the speed of the host vehicle is less than the second reference speed.

### APPENDIX 12

The vehicle control device according to Appendix 1, wherein the processor is further configured to
set the first inter-vehicle distance when the distance of the front vehicle with respect to the host vehicle is less than or equal to a predetermined reference distance, and
set the second inter-vehicle distance when the distance of the front vehicle with respect to the host vehicle is above the predetermined reference distance.

### APPENDIX 13

A computer-readable, non-transitory storage medium storing a computer program for controlling a vehicle, which causes a processor to execute a process, the process comprising:
determining whether there is a merging terrain where an adjacent lane adjacent to a traveling lane in which a host vehicle is traveling disappears by merging with the traveling lane within a first predetermined range from a current position of the host vehicle toward a traveling direction based on map information,
determining whether there is a front vehicle traveling in the traveling lane ahead of the host vehicle within a second predetermined range from the host vehicle and determine whether there is an adjacent vehicle traveling in the adjacent lane within a third predetermined range from the host vehicle based on surrounding environment information of the host vehicle, when it has been determined that there is the merging terrain,
estimating whether the adjacent vehicle moves into the traveling lane ahead of the host vehicle in the merging terrain based on distance of the front vehicle with respect to the host vehicle, distance of the adjacent vehicle with respect to the host vehicle, and speed of the host vehicle, when it has been determined that there is the front vehicle and there is the adjacent vehicle, and
setting a first inter-vehicle distance between the front vehicle and the host vehicle in the traveling lane based on the distance of the front vehicle with respect to the host vehicle and the speed of the host vehicle or set a second inter-vehicle distance between the adjacent vehicle and the host vehicle in the traveling lane based on the speed of the host vehicle, when it has been estimated that the adjacent vehicle moves into the traveling lane ahead of the host vehicle.

### APPENDIX 14

A method for controlling a vehicle carried out by a vehicle control device, and the method comprising:

determining whether there is a merging terrain where an adjacent lane adjacent to a traveling lane in which a host vehicle is traveling disappears by merging with the traveling lane within a first predetermined range from a current position of the host vehicle toward a traveling direction based on map information,
determining whether there is a front vehicle traveling in the traveling lane ahead of the host vehicle within a second predetermined range from the host vehicle and determine whether there is an adjacent vehicle traveling in the adjacent lane within a third predetermined range from the host vehicle based on surrounding environment information of the host vehicle, when it has been determined that there is the merging terrain,
estimating whether the adjacent vehicle moves into the traveling lane ahead of the host vehicle in the merging terrain based on distance of the front vehicle with respect to the host vehicle, distance of the adjacent vehicle with respect to the host vehicle, and speed of the host vehicle, when it has been determined that there is the front vehicle and there is the adjacent vehicle,
setting a first inter-vehicle distance between the front vehicle and the host vehicle in the traveling lane based on the distance of the front vehicle with respect to the host vehicle and the speed of the host vehicle or set a second inter-vehicle distance between the adjacent vehicle and the host vehicle in the traveling lane based on the speed of the host vehicle, when it has been estimated that the adjacent vehicle moves into the traveling lane ahead of the host vehicle.

The invention claimed is:

1. A vehicle control device comprising:
a processor configured to:
determine whether there is a merging terrain where an adjacent lane adjacent to a traveling lane in which a host vehicle is traveling disappears by merging with the traveling lane within a first predetermined range from a current position of the host vehicle toward a traveling direction based on map information,
determine whether there is a front vehicle traveling in the traveling lane ahead of the host vehicle within a second predetermined range from the host vehicle and determine whether there is an adjacent vehicle traveling in the adjacent lane within a third predetermined range from the host vehicle based on surrounding environment information of the host vehicle, when it has been determined that there is the merging terrain,
estimate whether the adjacent vehicle moves into the traveling lane ahead of the host vehicle in the merging terrain based on distance of the front vehicle with respect to the host vehicle, distance of the adjacent vehicle with respect to the host vehicle, and speed of the host vehicle, when it has been determined that there is the front vehicle and there is the adjacent vehicle, and
set a first inter-vehicle distance between the front vehicle and the host vehicle in the traveling lane based on the distance of the front vehicle with respect to the host vehicle and the speed of the host vehicle or set a second inter-vehicle distance between the adjacent vehicle and the host vehicle in the traveling lane based on the speed of the host vehicle, when it has been estimated that the adjacent vehicle moves into the traveling lane ahead of the host vehicle.

2. The vehicle control device according to claim 1, wherein the processor is further configured to set a value obtained by adding the distance of the front vehicle with respect to the host vehicle with a distance determined based on the relationship between the distance of the adjacent vehicle with respect to the host vehicle and the speed of the vehicle when the adjacent vehicle moves into the traveling lane ahead of the host vehicle, as the first inter-vehicle distance.

3. The vehicle control device according to claim 2, wherein the processor is further configured to set the first inter-vehicle distance so that the adjacent vehicle is positioned between the front vehicle and the host vehicle.

4. The vehicle control device according to claim 2, wherein the processor is further configured to:
determine whether there is another adjacent vehicle traveling behind the adjacent vehicle in the adjacent lane within a fourth predetermined range from the host vehicle, and
set the first inter-vehicle distance to be a length at which another adjacent vehicle cannot be located between the front vehicle and the host vehicle based on the distance of the front vehicle with respect to the host vehicle, distance of another adjacent vehicle with respect to the host vehicle and the speed of the host vehicle, when it has been determined that there is another adjacent vehicle and it is estimated that the adjacent vehicle moves into the traveling lane ahead of the host vehicle.

5. The vehicle control device according to claim 2, wherein the processor is further configured to set the first inter-vehicle distance equal to or below a length determined based on the relationship between the distance of the front vehicle with respect to the host vehicle and the speed of the host vehicle.

6. The vehicle control device according to claim 1, wherein the processor is further configured to estimate whether the adjacent vehicle moves into the traveling lane ahead of the host vehicle using a regression equation in which the distance of the front vehicle with respect to the host vehicle, the distance of the adjacent vehicle with respect to the host vehicle and the speed of the vehicle are variables.

7. The vehicle control device according to claim 1, wherein the processor is further configured to set a length determined based on the relationship between the distance of the adjacent vehicle with respect to the host vehicle and the speed of the host vehicle when the adjacent vehicle moves into the traveling lane ahead of the host vehicle, as the second inter-vehicle distance.

8. The vehicle control device according to claim 1, wherein the processor is further configured to:
estimate whether the adjacent vehicle moves into the traveling lane ahead of the host vehicle in the merging terrain based on the distance of the front vehicle with respect to the host vehicle, the distance of the adjacent vehicle with respect to the host vehicle, and speed of the host vehicle, when an absolute value of relative speed of the adjacent vehicle with respect to the host vehicle is equal to or above a first reference speed, and
estimate whether the adjacent vehicle moves into the traveling lane ahead of the host vehicle in the merging terrain based on the distance of the front vehicle with respect to the host vehicle and the distance of the adjacent vehicle with respect to the host vehicle, when the absolute value of relative speed of the adjacent vehicle with respect to the host vehicle is less than the first reference speed.

9. The vehicle control device according to claim 1, wherein the processor is further configured to:
estimate whether the adjacent vehicle moves into the traveling lane ahead of the host vehicle in the merging terrain based on the distance of the front vehicle with respect to the host vehicle, the distance of the adjacent vehicle with respect to the host vehicle, and speed of the host vehicle, when the speed of the host vehicle is equal to or above a second reference speed, and
estimate whether the adjacent vehicle moves into the traveling lane ahead of the host vehicle in the merging terrain based on the distance of the front vehicle with respect to the host vehicle and the distance of the adjacent vehicle with respect to the host vehicle, when the speed of the host vehicle is less than the second reference speed.

10. The vehicle control device according to claim 1, wherein the processor is further configured to:
set the first inter-vehicle distance when the distance of the front vehicle with respect to the host vehicle is less than or equal to a predetermined reference distance, and
set the second inter-vehicle distance when the distance of the front vehicle with respect to the host vehicle is above the predetermined reference distance.

11. A computer-readable, non-transitory storage medium storing a computer program for controlling a vehicle, which causes a processor to execute a process, the process comprising:
determining whether there is a merging terrain where an adjacent lane adjacent to a traveling lane in which a host vehicle is traveling disappears by merging with the traveling lane within a first predetermined range from a current position of the host vehicle toward a traveling direction based on map information;
determining whether there is a front vehicle traveling in the traveling lane ahead of the host vehicle within a second predetermined range from the host vehicle and determine whether there is an adjacent vehicle traveling in the adjacent lane within a third predetermined range from the host vehicle based on surrounding environment information of the host vehicle, when it has been determined that there is the merging terrain;
estimating whether the adjacent vehicle moves into the traveling lane ahead of the host vehicle in the merging terrain based on distance of the front vehicle with respect to the host vehicle, distance of the adjacent vehicle with respect to the host vehicle, and speed of the host vehicle, when it has been determined that there is the front vehicle and there is the adjacent vehicle; and
setting a first inter-vehicle distance between the front vehicle and the host vehicle in the traveling lane based on the distance of the front vehicle with respect to the host vehicle and the speed of the host vehicle or set a second inter-vehicle distance between the adjacent vehicle and the host vehicle in the traveling lane based on the speed of the host vehicle, when it has been estimated that the adjacent vehicle moves into the traveling lane ahead of the host vehicle.

12. A method for controlling a vehicle carried out by a vehicle control device, and the method comprising:
determining whether there is a merging terrain where an adjacent lane adjacent to a traveling lane in which a host vehicle is traveling disappears by merging with the traveling lane within a first predetermined range from a current position of the host vehicle toward a traveling direction based on map information;
determining whether there is a front vehicle traveling in the traveling lane ahead of the host vehicle within a second predetermined range from the host vehicle and determine whether there is an adjacent vehicle traveling in the adjacent lane within a third predetermined range from the host vehicle based on surrounding environment information of the host vehicle, when it has been determined that there is the merging terrain;
estimating whether the adjacent vehicle moves into the traveling lane ahead of the host vehicle in the merging terrain based on distance of the front vehicle with respect to the host vehicle, distance of the adjacent vehicle with respect to the host vehicle, and speed of the host vehicle, when it has been determined that there is the front vehicle and there is the adjacent vehicle; and
setting a first inter-vehicle distance between the front vehicle and the host vehicle in the traveling lane based on the distance of the front vehicle with respect to the host vehicle and the speed of the host vehicle or set a second inter-vehicle distance between the adjacent vehicle and the host vehicle in the traveling lane based on the speed of the host vehicle, when it has been estimated that the adjacent vehicle moves into the traveling lane ahead of the host vehicle.
